(19) United States
(12) Patent Application Publication
(10) Pub. No.: US 2005/0209892 A1
(43) Pub. Date: Sep. 22, 2005

(54) [Automated system and method for providing accurate, non-invasive insurance status verification]

(76) Inventor: Jonathan K. Miller, Conyers, GA (US)

Correspondence Address: Jonathan Miller, 2727 Old Salem Road, Conyers,, GA, 30013, US

(21) Appl. No.: 10/708,709

(22) Filed: Mar. 19, 2004

(51) Int. Cl. G06F 17/60

(52) U.S. Cl. 705/4

(57) ABSTRACT

The present invention relates generally to automatic insurance verification, and more specifically, to a non-invasive method and system for automatically determining, by any person with computer, wireless, or telephone access and in real-time, if an insured object of value is or is not insured irrespective of insurer location, jurisdiction, language, type, time, and also the internal operations, software platform and communications protocols used by insurers and/or governmental entities. It is an insurance verification, not an insurance reporting or tracking system and because it maintains no personal data of any kind, and can modify no record, it can deliver only very limited features regarding reporting or tracking. The present invention can however, provide absolute assurance of current insurance status at all times, provides a unique method of access which resolves all current failures and is non-invasive, providing complete privacy for all parties involved, (the absence of all personal information and the access method used ensures that all access and data is inherently non-invasive). This invention further ensures that any check of status, at insurer or governmental registration, (including “e-registration”, inspection, or any other location and time when and where a jurisdiction or insurer requires such a status check, will result in an instant and totally accurate status response. This system is based upon the assignment of a unique identifier, also known in this present art as a “UC” or “Unique Code” which then provides a method of accurate data, (including status checks), without reliance on “VINs”, (vehicle identification numbers), policy number or other identifiers which are often incorrect. The UC is assigned to any combination of two or more elements that are “gleaned”, (file field extraction and related system and methods), one of which is always current status. The extraction of these selected fields from data streams may be done by a number of prior art techniques, and the three most common have been detailed. First demonstrated to government officials in 1999 as a medical version and later the same year as a vehicle version, it has been demonstrated and documented since to a great many Federal and State governmental entities. This present invention has also been demonstrated to several foreign governments but incorporates no technologies that create any possible security risk for any government, insurer, individual, and especially to the national security of the United States.

### CROSS REFERENCE TO RELATED APPLICATIONS

U.S. Patent Documents: U.S. Pat. No. 4,491,725 January, 1985 Pritchard, 235/375 U.S. Pat. No. 4,989,144 January, 1991 Barnett, III. 364/409 U.S. Pat. No. 5,351,302 September, 1994 Leighton et al. 380/30 U.S. Pat. No. 5,521,815 May, 1996 Rose, Jr. 705/28 U.S. Pat. No. 5,832,447 November, 1998 Ricker, et al. 705/2 U.S. Pat. No. 6,031,625 June, 1997 Sherman, et al. 358/1.18 U.S. Pat. No. 6,233,563 February, 1999 Jefferson 705/4 U.S. Pat. No. 6,437,690 September, 2000 Okezie 340/505 U.S. Pat. No. 4,965,763 October, 1990 Zamora, Elena M., 364/900 U.S. Pat. No. 6,076,064 March, 1998 Rose Jr., 705/1 U.S. Pat. No. 5,325,291 October, 1992 Garrett, Thomas L., 364/401.

### BACKGROUND OF INVENTION

The present invention relates generally to a method for determining insurance status verification on an object of value and, more particularly, to a system and method for both instantly and automatically verifying the presence or absence of insurance coverage without regard to insurer or jurisdiction. It is an insurance verification, not an insurance reporting or tracking system, and because it maintains no personal data of any kind, and can modify no record, it can deliver only very limited features regarding reporting or tracking. The present invention can however, provide absolute assurance of current insurance status at all times, provides a unique method of access which resolves all current failures and is non-invasive, providing complete privacy for all parties involved. This invention further ensures that any check of status, at insurer or governmental registration, (including “e-registration”), inspection, or any other location and time when and where a jurisdiction or insurer requires such a status check, will result in an instant and totally accurate status response.

The uninsured status of various objects of value, especially vehicles and equipment, continues to create a serious financial and, in many cases a safety burden on Society. Insurance rates continue to increase, due in part, to the continued existence of large numbers of uninsured vehicles and numerous other items which otherwise appear to be insured. In regards to vehicles alone, the failures of current systems, according to FBI (Federal Bureau of Investigation) statistics, cost the owners of motor vehicles, and their insurers over $9B (nine billion dollars) in paid claims on motor vehicles alone, and another estimated $12-13B (twelve to thirteen billion dollars) in related damages for vehicle theft and theft-related fraud annually, and many insurance analysts claim these estimates are far too conservative. Also, these numbers do not reflect the cost of uninsured motorist coverage which adds additional billions. Additionally, there are countless deaths each year attributable to drivers who would doubtless have stayed at home or found other means of transportation if they knew that, in driving and being checked in any manner, their uninsured status would have been immediately known. Once vehicle coverage is obtained and insurance documents are issued, there is little opportunity to again verify its existence and/or status.

There are many problems with all previous methods of insurance verification. Many insurers allow for insurance premiums to be paid in monthly installments. Insurance registration documents are issued after the first payment indicating that the object of value is insured for a certain period of time, generally either six months or a year, but if, after the first payment, the policyholder does not make any additional premium payments, the insurance coverage will no longer exist even though the policy holder's insurance documents indicate that the object of value is insured for an additional five or eleven months, etc. Prior to the development and implementation of the present invention, there has been no adequate verification technique capable of detecting lapses in insurance coverage.

A need has long existed for a universal, centralized system for instant, accurate insurance status verification. Records used for such verification continue to be maintained by various unrelated parties and often at disparate, off-site locations. Further, all attempts at providing a universal site for any jurisdiction, and centralizing such records to ensure that all information is current and accurate, have failed. Attempts to provide safe, non-invasive access to various, unrelated parties using a “client-server” atmosphere that is telephony or computer-based, have also demonstrably failed.

There are over 4300, (four thousand, three hundred), separate insurers licensed to provide property and casualty insurance policies in the United States alone, and it is not uncommon for a single State to have over one thousand such carriers providing such policies. There is almost an equal number of insurers licensed to provide other forms of insurance for additional objects of value and individuals. No legislation or regulation that requires current reporting will be acceptable by the insurance industry, (or if accepted, not without massive, negative financial impact), unless a solution can be provided that requires almost no cost or implementation effort, is non-invasive for both insurers and policyholders, provides solutions to internal and external fraud concerns, and once in place, requires little or no maintenance. All this is provided by the invention.

One indicator of the failures of current insurer and government efforts relates specifically to vehicle insurance. It is estimated that as much as thirty percent of all VINs, (vehicle identification numbers—the primary method of determining the identity of a particular vehicle), maintained by State Government DMVs, are incorrect. Since 1980, this 17-character vehicle identification number (VIN) is imprinted on each vehicle. The VIN is coded so that the first eleven characters usually represent the following: country of origin, vehicle type, number of passengers, restraint system, car manufacturer model identification, vehicle series, body type description, engine size, a check digit, model year and manufacturing plant. The last six digits are different for each vehicle. Prior to 1980, a nine character VIN was used, with different placement, but with similar results. It is very difficult to properly read, record and maintain records regarding such alphanumeric identifiers. Additionally, other methods of identification regarding a particular vehicle are also potentially inaccurate. There are at least three parties creating detailed records of each vehicle independently. As discussed, the manufacturer stamps a vehicle identification number (VIN) on the vehicle which is coded to reveal particular information about the vehicle; and then each individual jurisdiction (State, District or Province) issues a “new” title number each time a vehicle changes owners, (and new registration plates and related documents every time insurance or ownership changes), and an insurer in the insurance industry maintains totally separate and different identifiers.

Current government systems use dissimilar multi-key tracking. For example, in dealing with vehicles, The VIN, title and the registration license plate must be combined, and the three keys “matched” to the owner, and then sent to another file or database program to “contextually cross-match” the data files to see if there is a match (as disclosed in U.S. Pat. No. 4,989,144 to Barnett III) and then the process must be reversed to all three or four “data-tracking keys” to update each file in the disparate databases while still maintaining a further “contextually-matched” database. Similar methods, (and resultant inefficiencies) are common in the maintenance of land and title deeds and records of all kinds regarding taxable objects of value. The present invention corrects these failures by providing a unique identifier to the object of value, and which circumvents the need for accurate records elsewhere. Even if other identifiers are incorrect, the “UC”, (Unique Code—a unique, numeric-only identifier, issued and used only once), provides access to accurate status data.

This same concern is seen in numerous additional patents, (as disclosed in U.S. Pat. No. 6,233,563 to Jefferson, as disclosed in U.S. Pat. No. 6,076,064 to Rose, Jr., and as disclosed in U.S. Pat. No. 6,437,690 to Okezie). Almost all States, Provinces, Nations and other such jurisdictions have tax or registration databases, which currently contain insurance status information on objects of value recorded and also perhaps registered in that jurisdiction. Instant access to database(s) in which the status data cannot be known to be accurate is simply a potentially better method of obtaining data that still cannot be trusted and properly used. The present invention provides instead, access to a database resident on either a dedicated server or server node in either a secure private facility or in a government computer system facility dedicated for such use. Access to government-maintained databases is typically provided, under some security provisions, to most governmental agencies, such as “DMVs”, (Departments of Motor Vehicles), State Police, the Courts, and also, in many cases regarding objects such as land and buildings, to any member of the general public. Access to the dedicated database, (which is not typically maintained by a jurisdiction), is available to anyone with telephony and/or computer access. Access to this system to obtain status can be made via direct, intranet, or internet link, but those methods have been available previously in prior art. The present invention adds one new method of status verification, which is telephone access, including “IVR”, (Interactive Voice Response) and touch-tone use as well. This is made possible by use of the aforementioned unique identifier, (also referred to as the “UC” or “unique code” in regards to the present invention).

Additionally, while numerous patents have provided potential answers to the tracking of objects of value, as disclosed in the previously referenced U.S. Pat. No. 6,076,064 to Rose, Jr., and disclosed in U.S. Pat. No. 6,233,563 to Jefferson, et al.), no prior art has properly addressed the issues of ensuring that status data is curren. Tthis invention does so by providing software that ensures status data is always current and reflects exactly and only what each insurer says the status of each policy is at any specific time.

One attempt to protect against fraud in motor vehicle transactions is disclosed in the aforementioned U.S. Pat. No. 4,989,144 to Barnett III. It teaches to identify discrepancies in existing vehicle title information by gathering recent title transaction data from a plurality of sources indexed by the VIN. It then adds records to a master database having a plurality of standard variable format transaction records indexed by the VIN. When a report is requested, all records indexed by the same VIN are selected and discrepancies are identified by “contextual analysis”. One of the numerous problems associated with this system is that it relies on a comparison of records kept by others. It does not correct any discrepancies in those records, nor does it provide any means for eliminating the errors when the data is originally input into the various databases. Further, it requires that data be kept by various, independent entities, and then redundantly researched time and time again (even for that same vehicle) because that vehicle may change jurisdictions and/or owners many times in its life cycle. Further, it will be readily apparent that 1000 vehicles can be reviewed “contextually” with ease, but 200 million vehicles become much more difficult. The present invention, while not a tracking system and not designed to ensure that all registration elements are correct and legitimate, does provide one certain data element that can be used to protect the parties involved. The “UC”, (“unique code” or unique identifier), can be linked to an exact vehicle, (or other object of value in exactly the same manner), and the insurance status instantly known, thus eliminating all problems associated with the use of incorrect identifiers, (which are very common), and changes regarding previously-referenced “contextual analysis” issues.

There are numerous additional problems with all previous methods of insurance verification. Many insurance companies allow for premiums to be paid in monthly installments. Insurance policy identification cards or other documents are issued after the first payment indicating that the policyholder is insured for a certain period of time, generally either six months or a year. If additional premium payments are not continued, the insurance coverage will no longer exist even though the policyholder or owner's insurance documentation will indicate that insurance is in effect for additional months. Prior to the development and implementation of the present invention, there has been no adequate verification technique capable of detecting lapses in insurance coverage.

This invention ensures that any check of status, at registration, (including “e-registration”), inspection, court appearances, or any other location where a jurisdiction requires or may require such a status check, will result in an instant and totally accurate status response. This provision is due to “gleaner” software, currently written in Java and XML, but which might be written in any one of several current or future platforms and operating systems that is “agnostic”, (transparent to and accepting of various platform and operating system software products), which monitors data streams without passing firewalls or interfacing with insurer or government databases. It looks for the manufacturer's identification number, or similar identifier, (or it may be the policy number in the case of a “deactivate” notice), then seeks status data in another field, (an approval code, renewal, or a “deactivation” notice, (suspension, cancellation or termination), and upon seeing both of the two required data elements, captures those fields and also the policy number and/or other field(s) as directed by the insurer and/or jurisdiction, and as directed by decisions recorded previously using the present invention's table-driven set-up system. The present invention relates therefore, to the retrieval of very limited data from either a data stream of files in underwriting, (which may be on either an insurer server or on a server providing such services on behalf of an insurer) or other approval system, (an element the present invention refered to as “FEG”, or “Front End Gleaner”, or a database with approved policy initiations, (both new policies and additional vehicles being added to existing policies). Likewise, the present invention is used in the same manner regarding the “REG” or “Rear End Gleaner” which also monitors and gleans from report data streams, (as it is there that notices of policy terminations, suspensions and cancellations, etc., occur). The forwarding of data from both gleaners via the insurer's existing reporting communication system, and the maintenance of such retrieved data in multiple databases for instant access can then be effected. Since the only data captured and maintained is supplied directly by insurers, and no modifications to this data is possible, all parties are assured that such information supplied is accurate. For those insurers who wish to use them, two additional versions of the software are available, but both operate in general terms as described previously. One of these additional versions allows an insurer to use the software directly under full control, so that control of when the gleaner is activated is determined by same, but the software described earlier accomplishes exactly the same task in the identical manner otherwise, and there is also another version which allows an insurer to simply send “book of business”, (entire files), to the dedicated database which, identifying the insurer's NAIC, (National Association of Insurance Commissioner's) five digit insurer identification code, and activating that specific profile, (choices documented previously by that insurer), then “gleans” the data as described previously, assigning a “UC” to the file, keeping only the very limited data required for operation of the present invention and immediately returning these same files with their assigned “UCs”. This same version can be used to handle insurer legacy data and government databases of insured vehicles in exactly the same manner. In short, the present invention is not limited to use in a specific site, but can accomplish the assigned tasks involved in any of a number of locations. The function of the present invention, in all cases however, never changes.

It is essential that the retrieving of such data, the maintenance of this data and the method of access to same, all occur in a non-invasive manner. This is provided by the present invention. No names addresses, or other personal data is maintained. Unfortunately, this means that the present invention cannot, for example, provide information on a potential terrorist. Fortunately, it also means that the present invention cannot be used to invade the privacy of any insurance policyholder and can also not target any person or group.

It is important to provide an overview of both the internet and relational databases in explaining the use of the invention.

An important use of computers is the transfer of information over a network. Currently, the largest computer network in existence is the Internet. The Internet is a worldwide interconnection of computer networks that communicate using a common protocol. Millions of computers, from low-end personal computers to high-end super computers are coupled to the Internet.

The Internet grew out of work funded in the 1960s by the U.S. Defense Department's Advanced Research Projects Agency. For a long time, the Internet was used primarily by researchers in universities and national laboratories to share information. As the existence of the Internet became more widely known, many users outside of the academic/research community (e.g., employees of large corporations) started to use the Internet to carry electronic mail.

In 1989, from Geneva, Switzerland, a new type of information system known as the World-Wide-Web (“the Web”) was introduced to the Internet. Early development of the Web took place at CERN, the European Particle Physics Laboratory there. The Web is a wide-area hypermedia information retrieval system aimed to give wide access to a large universe of documents. At that time, the Web was known to and used by the academic/research community only. There was no easily available tool, which allowed a technically untrained person to access the Web.

In 1993, researchers at the National Center for Supercomputing Applications (NCSA) released a Web browser called “Mosaic” that implemented a graphical user interface (GUI). Mosaic's graphical user interface was simple to learn, yet powerful. The Mosaic browser allows a user to retrieve documents from the World-Wide-Web using simple point-and-click commands. Because the user does not have to be technically trained and the browser is pleasant to use, it had the potential of opening up the Internet to the masses.

The architecture of the Web follows a conventional client-server model. The terms “client” and “server” are used to refer to a computer's general role as a requester of data (the client) or provider of data (the server). Under the Web environment, Web browsers reside in clients and Web documents reside in servers. Web clients and Web servers communicate using a protocol called “Hypertext Transfer Protocol” (HTTP). A browser opens a connection to a server and initiates a request for a document. The server delivers the requested document, typically in the form of a text document coded in a standard Hypertext Markup Language (HTML) format, and when the connection is closed in the above interaction, the server serves a passive role, i.e., it accepts commands from the client and cannot request the client to perform any action.

The communication model under the conventional Web environment provides a very limited level of interaction between clients and servers. In many systems, increasing the level of interaction between components in the systems often makes the systems more robust, but increasing the interaction also increases the complexity of the interaction and typically slows the rate of the interaction. Thus, the conventional Web environment provides less complex, faster interactions because of the Web's level of interaction between clients and servers.

The development of relational databases such as Oracle, and SQL has revolutionized business use for vehicle insurers and the emergence of XML, Java and similar efficient, system and platform-independent, (“agnostic”), software tools, with the development and supply of ever-more sophisticated “open source” application software based on such relational databases for insurers, continues to revolutionize that industry. While the present invention does not require access to any vehicle insurer or governmental relational database to operate, it must support the use of such databases on behalf of insurers and governments, it uses such a database to provide information form its own dedicated server, and it uses software and technologies developed for both relational databases and internet use, such as XML and Java, to accomplish its tasks.

It's difficult to imagine a world without databases. Every time you withdraw cash from an ATM, make airline reservations, or charge something on your credit card, database systems are working behind the scenes. Since the development of the relational database model in 1970, database technology has evolved rapidly and is now essential to just about all transaction processing and business intelligence applications. This is increasingly true of the insurance industry. This evolution continues, with innovations such as Real Application Clusters and integrated XML capabilities. From their beginnings, Relational database companies like ORACLE, Sybase, Informix, Ingres and IBM, were dedicated to a philosophy of “portability, compatibility, and connect ability”, the very essence of open-system computing. In contrast to closed, proprietary approaches that lock a customer into a particular vendor's solution, the open systems market allows customers to benefit from the lower costs and faster rates of innovation that are the result of competition, and these relational databases continue to be positioned as the cornerstone of insurer computing systems, as insurers move away from older technologies. In the world of underwriting, so important to the use of this invention, the value of relational databases is unquestioned.

The relational database revolution began when IBM researcher Dr. Edgar Codd published the paper “A Relational Model of Data for Large Shared Data Banks.” Oracle Chairman and CEO Larry Ellison, along with friends and former coworkers Bob Miner and Ed Oates, had started a consultancy called Software Development Laboratories (SDL) in Silicon Valley. Ellison and Miner read Codd's paper and another paper published in the November 1976 IBM Journal of R&D that described a preliminary version of the SQL language. Ellison saw tremendous business potential in database software, and he and his cofounders at SDL began building what would become the first commercially available relational database management system.

What continues is a short historical overview of relational database development, focusing on Oracle, which is perhaps the most popular of both insurance company and State government relational database platforms. The provision of this historical insight is intended to further explain the use of relational databases for insurers, State governments, and in support of the present invention. In providing this, it hoped that it will also be clear why it is so important that this invention operate without passing firewalls or require interface with such databases under the control of insurers or governments. The role of the invention is to support the systems of the insurers and governments, requiring as little modification as possible and none at all of their relational databases.

The SDL Management, referenced above, called their finished product Oracle, after the code name of a CIA-funded project Ellison and Miner had worked on at a previous employer, (Ampex). Later, the CIA was one of Oracle's first customers and remains one of its largest. Later, the name of SDL was changed to RSI, then to Oracle to identify more closely with the product.

Oracle was first offered commercially in the summer of 1979 on Digital Equipment PDP-11 minicomputers. The new database product incorporated a reasonably complete implementation of SQL, including sub queries, joins, and other features, but it was not very reliable and lacked certain important functionality such as transactions. This first version was called Oracle 2 because it was decided that few customers would buy the product if they knew it was the first version.

In 1983, a new version of Oracle was released that was entirely re-written in the then-new C programming language, increasing its portability beyond the range of operating systems that ran on the DEC PDP-11. Oracle Version 3 also introduced atomic execution of SQL statements and transactions. This meant that unlike in Oracle version 2, a SQL statement would succeed or fail in its entirety, and transactions would be either committed or rolled back fully. It also introduced non-blocking queries, using data saved in a “before image file” for both queries and transaction rollback, thus avoiding the use of read locks, (even though its throughput was limited by use of table-level locking).

A year and a half later, in 1984, Oracle 4 was released with improved stability and a new feature called read consistency—the assurance that a query will see a set of data that remains consistent during execution. This meant that money shifted between policies or bank accounts during a query would not be miscomputed and employees, added to an HR data base during a query not be miscounted.

In 1985 and 1986, Oracle released versions 5 and 5.1 which were remarkable in that they were among the first client/server RDBMS, (Relational Data Base Management Systems), so that business applications running on desktop PCs (clients) could access a database server over a network. It was this and similar RDBMS that so greatly impacted the prior art referenced and has served in helping make the present invention possible. Version 5.1 also supported distributed queries, allowing a single query to access data stored in multiple locations.

Oracle version 6, released in 1988 was scalable. It introduced a new architecture for enhanced performance, scalability and availability. One of the most important features was row-level locking—a transaction performing writes locks only the affected rows (not an entire table), resulting in improved system throughput when many users access the same data. It also had backups, allowing a database to be backed up while in use.

After years of intense research, Oracle 7 was released in 1992, and introduced new performance features, distributed transactions, administration enhancements, new tools for application development, and security methods. Oracle 7 also included new capabilities such as stored procedures, triggers, and declarative referential integrity, making the data base programmable and able to enforce business rules.

In 1997, Ellison unveiled Oracle 8, which laid the groundwork for supporting the internet, network computing and new types of information. It also included support for object-oriented development and multi-media applications. This was followed fifteen months later with Oracle8i, (i for “internet”), which supported internet-based activities and applications. Oracle 8i became the first database to incorporate a native Java runtime environment, allowing stored procedures and triggers to be written in the Java language, which was gaining popularity. It also supported SQLJ, an open standard for embedding SQL database statements into client or serverJava code, and Oracle interMedia for managing multimedia content.

Oracle 9i, was certainly Oracle's most significant release ever, and contained technologies that forever changed he computing landscape. Among its 400 new features is Real Application Clusters, a unique technology that permits multiple clustered computers to share access to a single database for new levels of scalability, availability, and affordability. Besides offering greatly improved security, it also contains integrated business intelligence. Release 2 of “9i” made Oracle a native XML database; it contains a powerful facility for storing and accessing XML documents, putting SQL and XML on equal footing.

Oracle was the first RDBMS available on Linux, and has contributed key technologies to the open source community, (memory management, I/O, and a clustered file system). In addition to supporting Linux, applications have been developed that run on clusters of commodity blade servers, or grids. Much like the utility grid that powers your home, grid computing delivers computing as a utility. On the server side, grid computing is about resource allocation, information sharing and high availability. Resource allocation ensures that everyone gets the processing cycles he or she needs and that resources don't sit idle if requests are pending. Information sharing ensures that information and applications are available where and when they're needed.

Insurers typically update policy “adds”, (newly insured objects of value covered by a new policy or added to an existing policy), only once each day. In some cases, over weekends or holidays, an “add” or “initiation” may take several days prior to being recorded in the “stacks”, (central files) of an insurer. In the interim, a “binder” (temporary document providing temporary coverage), is issued. In some cases, insurers may also report suspensions, terminations, cancellations, etc., only once each day, or as in the above case, only after a weekend or holiday period. The present invention is unaffected by any such insurer decisions and activity. It only reflects the insurer″s decision as to coverage, and can make no modification(s) to same.

Insurance binders as discussed above, provide a notice of temporary insurance coverage. Because underwriting systems, upon approval of an “add” or “initiation”, are also the business units that approve the issuance of a binder, such business units can provide additional, dramatic benefits to insurers by either using the unique identifier, “UC”, (unique code), as the binder number or by linking said unique identifier to the binder number. This feature benefits vehicle insurance policyholders in that it allows instant registration or asset use, should verification of active insurance status be required. If, for some reason, the “UC” used in registration or reporting is not soon reported to the appropriate entity/authority then “deregistration” or cancellation can then occur.

Policyholders can also benefit from the ability to check status of their insurance, (or that of anyone else), if a registration or insurance identification document is supplied, by the use of any telephone. An “800” telephone number and the UC that identifies that particular combination of item identifier, (manufacturer's identification number, “VIN” if a vehicle) or registration identifier and policy, (or other elements as directed by an insurer or government agency), can be printed on a registration or policy identification document and, this in turn provides instant access and response over any telephone. Because no names, addresses or other personal information is maintained, and only a code is used, the system is inherently non-invasive and privacy issues remain fully supported.

The benefits to insurers, in addition to supplying benefits to their policyholders by improving service, are dramatic. Their use of the “UC” enables their control of binder activity in a manner not possible previously except with “captive” agencies, (agencies that write for only one insurer and are on-line with same during business hours), and this greatly benefits insurers by reducing fraud losses. Premium diversion, “fund float”, back dated policies and many types of “repair scams”, can be instantly eliminated. While the system is capable of only very limited reporting, it can at least report when any product identifier is covered by two or more policies, then notify each insurer involved that there is a possible “repair or transfer scam” underway. It is archival, so it can also provide authorized insurers and government entities with information regarding periods and lapses of insurance coverage. Again, the APIs (Application Program Interfaces, also known as “software hooks”), are provided to each insurer to capture and use the “UC” in any manner desired. The decision(s) regarding how to best use these benefits remain, at all times, under the control of the insurer(s) and/or government(s) involved; it is simply the unique features of the present invention that make them possible.

Many States now require insurers to report insurance information electronically. The insurers and governments do so now via FTP, x.12, x.25 or similar communications protocols. The present invention requires no changes in this regard. The present invention enables a jurisdiction and insurer to enjoy the dramatic benefits associated with current reporting, without forcing unnecessary change, but is “pre-set” to automatically provide daily reporting, which, with binder use, ensures that information remains current and accurate. This feature can, however be changed by any insurer or authorized government entity controlling the verification database and using this system. The insurer or said governmental entity can determine to have an “open pipe” connection, operational “around the clock”, which supplies status data as it occurs or, if a very small insurer is responsible for reporting, said insurer may prefer to report only on the rare occasion that it has a policy change for that particular State. It is, after all, not the present invention's role to dictate to insurers what the status of any given policy should be or how it should be reported, but rather to simply enable the insurer or governmental entity in control to report as each decides. Likewise, it is the insurer's legal responsibility to provide coverage between the time of binding and reporting, so the present invention's data is, by definition, always current. Since the dedicated database involved is an exact reflection of what the insurers say their policy status is on any given policy, it is clearly in their own best interest to ensure prompt reporting. The present invention claims to be the first-ever “on-line/real-time” insurance status verification system, and is exactly that, as its status data is always accurate according to the insurers, and no other factor influences reporting of status, as there are no additional time constraints or delays.

The present invention provides access to status data at any time to anyone who has access to a computer, wireless PDA, telephone or similar device. It provides a simple, secure method of accident and theft reporting, and It enables, for the first time ever, everyone to fully participate in collective security, while providing better insurance service, increased respect for the law, and over time, lower insurance rates.

The tools and methodology now exist therefore, to provide an on-line/real-time, automatic and non-invasive insurance verification system that resolves all problems associated with prior art and this document records the existing system thus created.

### SUMMARY OF INVENTION

This invention provides accurate insurance status information for any object of value in real-time without regard to insurer or jurisdiction, location, language, type, time, and also the internal operations, software platform, and communications protocols used by insurers and/or governmental entities. It is an insurance verification, not an insurance reporting or tracking system, and because it maintains no personal data of any kind, and can modify no record, it can deliver only very limited features regarding reporting or tracking. The present invention can however, provide absolute assurance of current insurance status at all times, provides a unique method of access which resolves all current failures, allows access by any person with computer, wireless device using common protocols or telephony devices, access to status and the ability to report accidents and thefts. It is non-invasive, providing complete privacy for all parties involved. This invention further ensures that any check of status, at insurer or governmental registration, (including “e-registration”), inspection, or any other location and time when and where a jurisdiction or insurer requires such a status check, will result in an instant and totally accurate status result. It can be implemented due to government regulation, by the choice of insurers, or by both.

### BRIEF DESCRIPTION OF DRAWINGS

These Figures describe the two separate elements of the present invention.

FIGS. 1 through 4 describe the methodology involved in establishing and maintaining data available for access, while

FIG. 5 describes the access methods used to safely obtain said data for verification and the very limited reporting methods available.

FIG. 6 describes the methodology of the “gleaner”, (file field extraction and related methodology and systems), and

FIG. 7 is a sample page of a code sheet used to demonstrate how the gleaner element recognizes and captures data. More specifically: FIG. 1 is a logical flow chart of the overall method of the invention at origination, (insurer or government site). FIG. 2 is a logical flow chart of the overall method of the invention during data distribution and use. FIG. 3 is a system overview providing more detail of FIG. 1 in regards to the use of the present invention at an insurer's site. FIG. 4 is a system overview providing more details of FIG. 1 in regards to the use of the present invention at a government site. Figure 5 is a logical flow chart of the elements of the present invention used to access the data maintained by the present invention. FIG. 6 is a logical block diagram showing the overall method of the invention's file extraction element. FIG. 7 is a sample code sheet demonstrating a data stream structure common to insurers.

### DETAILED DESCRIPTION

The present invention seeks to overcome the deficiencies of prior art by providing a system and method for instantly and accurately verifying the existence of insurance without respect to insurer, location jurisdiction, language, type of insured item, time, and also the internal operations, software platform and communications protocols used by insurers and/or governmental entities. It can accomplish this in real-time, in total accuracy and in a noninvasive manner. It can be implemented due to government regulation, by the choice of insurers, or by both.

According to exemplary embodiments of the present invention, it provides required government reporting on behalf of insurers and also for the production of insurance policyholder documents and/or identification card(s), binder(s) or similar documents, (if required), eliminates many types of insurance fraud, including false insurance identification cards and other documentation, “back-dated” policies, “fund float”, various “repair scams”, and it dramatically reduces other costs to insurers, especially losses involving false property claims and uninsured vehicles.

All information supplied by the present invention is accurate at all times because it is always and only an exact reflection at any moment on any policy as reported by the insurer involved.

Implementation takes only minutes and except for the provision and assignment of a unique identifier referenced to two elements and optional government requirements, its use is determined entirely by the insurer. The insurer can even determine the manner and frequency of the present invention's use, provided said determination does not conflict with governmental requirements, (if any), and can determine the location of its use, even if at a site remote from that of the insurer, (such as the present invention's central, dedicated server or a governmental entity).

The present invention provides insurance verification via telephony or internet access at any time and to anyone without limitation because it is not limited in use to insurers or government agencies, but available to all.

The present invention is further distinguished by its ability to provide information on any policy without respect to location, jurisdiction, type of insured item, time, and also the internal operations, software platform, and communications protocols used by insurers and/or governmental entities.

The present invention is further differentiated in that it has no requirement to maintain names, addresses, or other personal details so that privacy issues are fully supported and no person or group can be identified and targeted in any manner.

The present invention is further differentiated in that it extracts and maintains status data without the requirement to utilize internet or telephony connections to contact an individual insurer regarding a specific policy or group of policies and with the attendant privacy, connectivity, and security issues involved in such prior art.

The present invention is further distinguished from prior art in that, extracting data from data streams or databases other than central “stacks”, (from data bases of pre-approved initiations, “adds” or terminations, suspensions, and cancellations), rather than said central insurer databases, it is non-invasive to said insurer databases.

The present invention is further differentiated in that, because of its unique architecture and features, the requirement to obtain and maintain large amounts of data does not exist, and, as a consequence, file sizes are exceptionally small, and response to and from the data maintained in the dedicated database is almost instantaneous.

The present invention is further distinguished by its ability to provide accurate information regarding multiple insurers, (an individual insurer may be able to provide current, accurate status regarding their own policies, but can supply no such information about the policies of other insurers).

The present invention is further distinguished by the extraction of data fields meeting governmental requirements and the automatic supply of same to government entities as designated by governmental requirements in order to meet the governmental reporting requirements of insurers.

The present invention is further distinguished by its ability to provide information with total accuracy as it is, by definition, always and only a reflection of the exact status reported by insurers and said invention can modify no elements of any insurer record of any kind, at any time.

It is an object of the present invention to provide a centralized uniform system for maintaining up-to-date and accurate insurance status for any given insurer, jurisdiction, and group or association of insurers.

It is another object of the present invention to provide a centralized, uniform system for maintaining up-to-date and accurate insurance status for any governmental entity(ies) and related organization(s), and association(s).

It is another object of he present pesent invention to provide a centralized uniform system for maintaining upto-date and accurate insurance for any given combination of insurer(s) and related organization(s), association(s), or business entity(ies).

It is yet another object of the present invention to provide information on any policy without respect to insurer, location, jurisdiction, language, type of insured object of value, time, and also the internal operations, software platform, and communications protocols used by insurers and/or governmental entities.

It is another object of the present invention to reduce the incidence of insurance fraud in Society, protecting both insurers and the public from such fraud.

It is another object of the present invention to provide for a single document with a single, master UC, (unique identifier), to make reference to the insurance status of multiple objects of value, each of which has, in turn, their own, individual UC assigned as described in both the preceeding and following sections of this document.

It is another object of the invention to enable law enforcement officers to know with certainty, the current status of iregarding a specific object of value.

It is another object of the invention to enable courts to know with certainty, the current status of insurance regarding a specific object f value on the date of citation and/or summons, and/or seizure and on the date prior to same, in order to determine that insurance was not purchased later the same day.

It is another object of the invention to enable government staff to know with certainty, the current insurance status of a specific object of value at time of registration, registration renewal, and at any other time required or desired.

It is another object of the invention to enable insurers to know with certainty, the current status of insurance regarding a specific object of value, to know periods of prior coverage and to know if there are two or more policies assigned to a particular identifier/registration number.

It is another object of the invention to extract and maintain status data without the requirement to utilize internet or telephony connections to check an individual insurer regarding a specific policy or group of policies and with the attendant privacy, connectivity, and security problems common to such prior art.

It is another object of the invention to extract data from data streams rather than passing firewalls and/or interfacing with central insurer databases being at all times, non-invasive to said insurer databases.

It is another object of the invention that, because of its unique architecture and features, it has no requirement to obtain and maintain large amounts of data and, because as a consequence of this, file sizes are exceptionally small, and as a further consequence, response time regarding queries to and responses from the dededicated database is almost instantaneous.

It is another object of the invention that the supply of its issued unique identifiers for use by insurers as binder numbers, (or referenced by binder numbers), enables policyholders and/or owners to immediately effect registration(s), purchase(s), sale(s) or other transactions desired without delay.

It is another object of the invention that the supply of its issued unique identifiers for use by insurers as binder numbers, (or referenced by binder numbers), enables owners of insured objects of value to use same immediately in compliance with any regulations, legislation, contracts, or agreements that require uch compliance.

It is another object of the invention that the supply of its issued unique identifiers for use by insurers as binder numbers, (or referenced by binder numbers), and also as the established means of access using same to insurance status information in future enables proper monitoring so that the failure to make a payment or other action that results in suspension, termination, or cancellation of a policy can be so reported and known the instant such action is determined and reported by insurer.

It is another object of the invention that as the addition of only the previously referenced “UC” (unique code also referred to as “unique identifier”), and a telephone number or web page which provides access to the previously referenced dedicated database for verification purposes using same and accessing insurance status, added to a printed paper, plastic, or other material insurance identification document, thus allowing a simple and accurate status verification, constitutes a complete anti-fraud device.

It is another object of the invention that it is to be further distinguished by the extraction of data fields meeting government requirements and the automatic supply of same to identification documentation manufacturers for production and supply of insurance policy identtification documents.

It is another object of the invention to provide insurers with all software system requirements to effect automatic government reporting of all insurance status requirements.

This to be accomplished by the extraction of data fields meeting said governmental and insurer requirements from any insurer underwriting system and the extraction of said data fields from any insurer status reporting system, avoiding at all times any insurer central database(s), and the automatic supply of same extracted data from the aforementioned sources to government entities as designated by said government requirements in order to meet the governmental reporting requirements of insurers.

It is another object of the invention, as an alternative to or in conjunction with above, to provide governmental entities with a software system requirements to effect automatic governmental reporting that meets all insurance status requirements. This is to be accomplished by the extraction of data fields meeting said governmental and/or insurer requirements from any insurance data initial “intake” processing system and/or the extraction of said data fields from any insurance data reporting system, and the automatic supply of same extracted data from the aforementioned source(s) to insurers and other parties as determined by said government entity(ies) and/or insurer(s).

It is another object of the invention that it can be, if an insurer wishes, automatic in operation so that once installed no additional involvement of said insurer is required.

It is another object of the invention that it can be, if an insurer or governmental entity wishes and so used at another site apart from that of insurer and/or government entity responsible for processing and maintaining insurer-supplied data.

It is another object of the the invention that, except for the extraction of data field elements required by governmental entity(ies), if any, and the assignment of a unique identifier to at least two such data field elements, the control of the present invention and each module therein, remains at all times with the insurer, who can activate or deactivate each at will, provided governmental requirements are met and data is sent on a timely basis so as to insure coverage is shown as “active” when the binder expires.

It is another object of the invention, in regards to vehicles and/or equipment owners, users and drivers to know with certainty, the current status of insurance regarding a specific vehicle or item of equipment.

It is another object of the invention to enable business owners, including rental agencies, vehicle and equipment dealers to know with certainty, the current status of insurance regarding a specific object of value.

It is another object of the invention to enable pedestrians; property owners or others involved in an accident or a claim to know with certainty the current status of insurance regarding a specific object of value.

It is another object of the invention to enable any member of the public to know with certainty, the current insurance status of on an object of value.

It is another object of the invention to ensure that no policyholder can be identified personally as no personal information of any kind is maintained, and that no individual or group can thus be “targeted” in any way.

It is another object of the invention to protect insurers against theft and theft-related fraud, especially in regards to false documents, “fund float”, premium diversion, and “repair scams”.

It is yet another object of the invention to assist in the elimination of the “after-market” for stolen items and their sub-parts and therefore, deter or eliminate such theft and theft-related fraud.

It is yet another object to eliminate the redundancy and associated costs and wasted effort and time involved when various parties maintain separate records of the same transaction(s).

It is yet another object to eliminate potential confrontations between those seeking to register or record an insured object of value and government employees and others responsible for assisting in such registration, by removing the burden of questionable insurance status from both parties.

It is another object to ensure that the system represented by the present invention be maintained in a congruent and continual manner, be backed-up by redundant systems and be available for query with no inoperable period(s).

It is another object to provide governmental entities, and especially law enforcement with a means of automatic notification of accidents or theft(s) to insurers involved in a manner that does not subject the transmission of information to or from said insurer to invasive methods and potential privacy concerns.

It is another object to provide policyholders with a means of automatic notification of accidents and thefts to their insurers in a manner that does not subject the transmission of information to or from said insurer to invasive methods and potential privacy concerns.

It is another object of this invention to provide a system, as aforesaid, which compensates for delay in the recordation of records in a government insurance status database. Thus, it is an object of the present invention to provide a centralized, uniform system for maintaining upto-date and accurate insurance status for any given jurisdiction.

It is still a further object of this invention to provide a system which supplies information which is totally accurate as it is, by definition, always and only an exact reflection of the exact status reported by multiple insurers and said system can modify no element(s) of any insurer record of any kind or at any time.

It is yet another object of this invention to provide accurate information regarding multiple insurers' policies and to then provide reports regarding same to insurers in the event that a single insured item of value has two or more policies associated with it, as that may be determined to be a possible case of fraud.

It is yet anther object of the present invention to provide insurance verification via telephony methods involving “IVR”, (Interactive Voice Response), so as to enable users to obtain status information more easily. This is enabled by the use of the “UC” (unique code, a form of unique identifier described previously).

The drawings or figures included in this document disclose illustrative embodiments of the invention. Given the benefit of this disclosure, those skilled in the art will appreciate that various modifications, alternate constructions, and equivalents may also be employed to achieve the advantages of the invention. Therefore, the invention is not to be limited to the above and following description and illustrations, but is only to be defined by this documentation and claims. These and other features and advantages of the present invention may be better and more completely understood by reference to the preferred exemplary embodiment in conjunction with the drawings that follow.

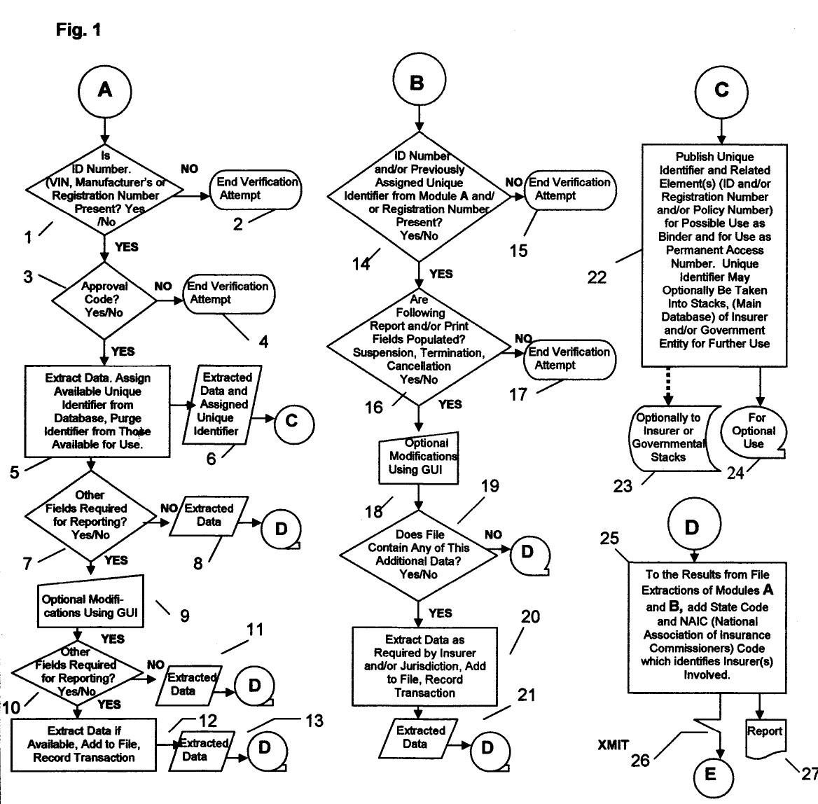

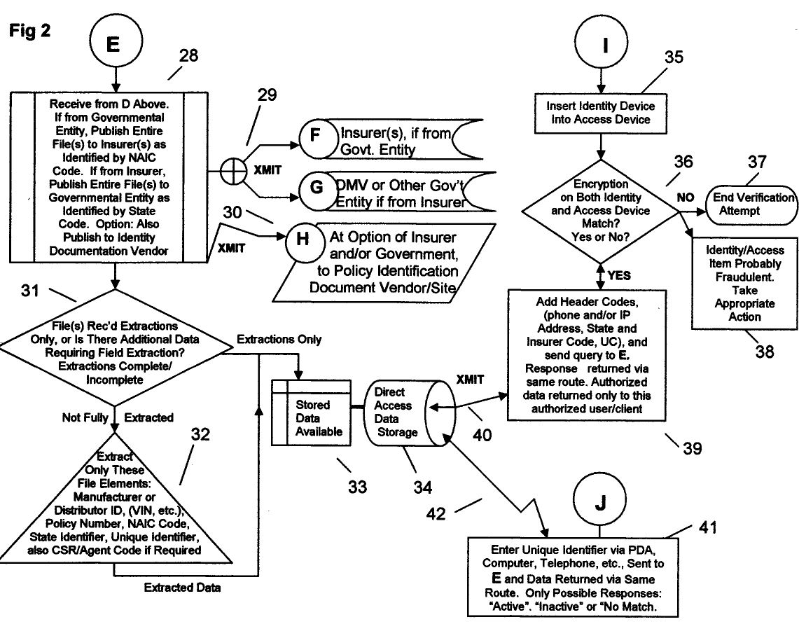

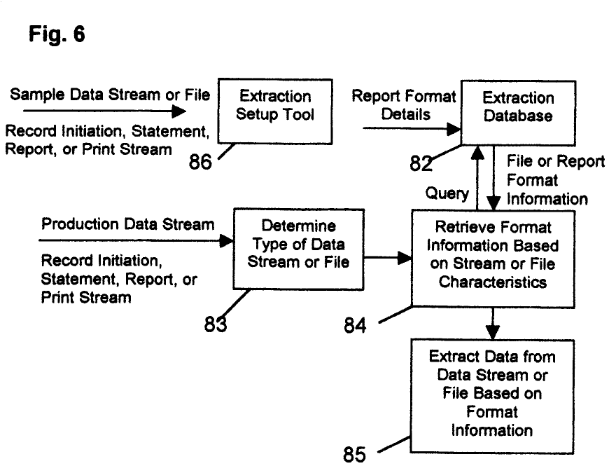

The general operational overview for the present invention is perhaps best demonstrated by means of the flow charts as seen in FIGS. 1 and 2, below. The process begins with a module referred to in the present invention as “FEG” or “Front End Gleaner” and is further identified as Module “A”. When, in FIG. 1, item 1, a data stream or database in which initial “intake” processing is done, (and which may or may not be on an additional server which is connected to the “intake” server), and which has been set up via a GUI, (“Graphic User Interface”), to monitor specific fields, (and may also monitor both the format of data and specific characters therein), detects such fields as populated and, if required, populated with the required characters and/or formats, (predetermined by use of GUI, as illustrated in more detail beginning with FIG. 6), the present invention is activated. The initial field will be the Identification number of the object of value. That in turn, is either the number assigned by the manufacturer or distributor, or a number provided by an oversight entity, (typically an association, retailer, or by a government entity). For example, in the case of a vehicle it would be the “VIN” (Vehicle Identification Number), if the system is being used at an insurer's site or on behalf of an insurer, and will either be the registration number, the proposed registration number or a (typically temporary) process code if at a government site or other site operating on behalf of the government. If the initial field does not meet the first pre-determined requirements, (manufacturer's identification, “VIN” or registration number, proposed registration number, or temporary process code), the attempt ends as illustrated by item 2.

If the initial requirement is met, then a second field, as illustrated by item 3, is read, (which constitutes the approval code field). It the apva code does not meet the predetermined requirements as created by the GUI, which may also require specific character(s) in said field, then the attempt ends as illustrated by item 4.

Item 5 illustrates the point at which a unique identifier, (in this case, a unique numeric number referred to in this art at “UC” or “unique code”) can be activated and assigned. This is further demonstrated as being sent to Module “C”, (Item 6). The present invention may require additional fields to be extracted prior extracted prior to this point, but the “UC”, which is extracted from a dedicated database of available numbers and assigned randomly, (whereupon that “UC” is eliminated from the pool of previously available “UCs”), can be assigned with only two fields, (in this case, the initial field illustrated as item 1 and the approval code illustrated as item 3).

Item 6, as described above, illustrates that the initial extracted data can, at this time, be made available to either government or insurer for use as a binder number or, (for similar purposes), linked to a binder number. A governmental entity may desire to use it as their temporary process code, as a registration number or as a link to a registration number. It is considered advantageous to insurers and governments to, at this time, utilize this number by adding it to an additional field or to an unused field in their intake document file in either underwriting if this is an insurer operation, or in the processing file if this is a government operation.

Item 7 illustrates that at this time, a decision must be made if there are additional fields that are required by the table-driven interface used previously and described beginning with FIG. 6. If not, then the extracted data elements are published, as illustrated by item 8, to a site to be distributed later, (and identified ndident as Module “D”), with other results from a separate module described in more detail later as the “REG”, or “Rear End Gleaner”, also identified as Module “B”.

Item 9 illustrates that this present invention remains, at all times, under the control of the insurer or government using it and said insurer or government may further modify, using the aforementioned GUI, the invention for additional report capabilities, which would not however, begin prior to this specific point in the operation of the present invention. If such a change took place, the present invention would first determine if further fields were required to have data extracted, (item 10), and if not, would send the notice that such data was not present as illustrated in item 11, and if there were fields that were required to have data extracted and those field(s) had such data, then, as illustrated by item 12, such data would be extracted and sent as illustrated by item 13 to the aforementioned Module “D” for distribution.

Item 14 represents the first element of Module “B” which is also known in the present invention as the “REG” or “RearEnd Gleaner”. Item 14 operates in the same manner as item 1, except that it is monitoring different fields for extraction and is doing so by monitoring either a print stream, print database, report stream or report database, or any combination of these, (as they are often seen and utilized as all the same, and are all the same for purposes of the present invention). If there is no manufacturer IDs, “VINs”, “UCs”, or registration numbers, then the present invention remains inactive as illustrated by item 15. If any of those elements or other fields representing those elements are present, then a decision must be made as illustrated by item 16. If there are any of the field(s) present, and if required, populated with characters which represent any form of termination or suspension of the policy or registration in question, as decided by insurer and/or government user(s) and which would have been so designated by use of the GUI described in FIG. 6, then this information is held and forwarded to another element, as illustrated by item 18, if not, then the verification attempt ends as illustrated by item 17.

Item 18 is identical in operation and function to item 9, except that its use is in a different module. It allows an insurer and/or government to modify at this point, the fields to be monitored and, if populated with required data, extracted. Item 19 then illustrates the next step which is a decision based on any such changes. If there are none, then the file is forwarded for distribution to Module “D”, but if so, item 20 illustrates the data element extraction and item 21, the data being forwarded, again, for distribution to Module “D”.

Item 22 illustrates the first element of Module “C” which was, to some degree, described previously. The “UC” and related manufacturer's identification number, (“VIN” or similar), and policy number and/or registration number or other codes or data representing the policy number and/or registration number are made avilable, as illustrated by items 23 and 24, for further use by insurer and/or government. In all cases, this use is optional and the insurer and/or government entity(ies) may decide to use this data or to not use it. That use at this point is a convenience to all concerned but its use or lack of use is not the basis of any claims of the present invention.

Item 25 illustrates the point at which the present invention prepares and then forwards the data collected by field extraction from the previously referenced “FEG”, (also identified as Module “A”) and the “REG”, (also identified as Module “B”). Each insurer has been assigned a five-digit number by the NAIC, (National Association of Insurance Commissioners). This data, along with the Federally assigned two character State Code, (CA, NY, GA, etc.), typically transmitted, (as is all else), in ASCII, is now ready for electronic transmission. Other codes and data as previously discussed may have been required by insurer and/or government and perhaps data requirements added as illustrated by items 9 and 18, and which might include for example, identifiers for the source, (Agent, “CSR”, (Customer Service Representative), which may have been added as well, but these decisions reside with insurer and/or government.

File transfer, as illustrated by item 26, may be by x.12, x.25, FTP, or any of a number of methods, which is not a proprietary element of the present invention. Typically, insurers already have such communication arrangements in place for current electronic government reporting requirements. If not, IBM WorldNet, ATT, Sprint, and other telephony companies, along with a great many software companies are eager to handle such details and do so with dependability and low cost. The present invention has only the restriction in that data made available by it must be transferred securely, (SHTTP, rather than HTTP). The present invention is not restricted to a specific encryption and governments and insurers are encouraged to use their own, and perhaps that of the telephony partner as well, if possible. Item 27 illustrates the creation of a record, (“log”) of all transmissions.

FIG. 2 begins with the receipt of data from either an insurer or government or site acting on behalf of insurer or goverand is illustrated as item 28. This is also the beginning of the present invention's “Module E”. If the data is received from the government or site acting on behalf of the government, t is immediately forwarded to the insurer(s) involved as illustrated by item 29, where data is sent to “F”. If the data is received from an insurer or site acting on behalf of the insurer, the file(s) is immediately forwarded to the government entity(ies) involved, as illustrated by item 29, where data is sent to “G”, and, if insurance identity documents are required to be printed, to the appropriate insurance identification documents vendor, as illustrated by item 30, where data is sent to “H”. Any and all file transfers are handled securely and with full encryption.

Additionally, item 28 utilizes pre-set criteria for file extraction as illustrated in item 31. If no further extractions are required, then the file is forwarded to item 33, where it is available for access via item 34, which represents the interface used for later access. Item 32 illustrates the specific files, (and only those files) which can be further extracted and maintained, if such further extraction is required.

If required, and once completed, the resultant data is forwarded to item 33 where it is stored and available for access as described previously.

FIG. 35 begins “Module I” which in turn, illustrates one of several methods of obtaining output or “end product” (accurate insurance status information), from the present invention. In this case, additional security features are demonstrated. An identity device representing claimed insurance is inserted into, or “scanned” or “read by”), an access device with connectivity features. One example of this might be that a vehicle insurance identification card which is an inexpensive memory-only chip card, (“smart card” that nevertheless has very limited data and no processing capabilities and is further distinguished as having a fusible link, making it a “WORM” (write once/read many) device), is inserted into a chip card reader. As illustrated by item 36, the access codes on both devices must match, and if not, the chip card is very possibly fraudulent, in which case the attempt to verify status is terminated and other appropriate actions may then be taken as determined by the government, insurer and others authorized by same. An example of just one such action is that a law enforcement officer might cite an individual who presented such an identification card. Items 37 and 38 illustrate these further actions.

If the access codes match, then the verification or access device used as further illustrated by item 39, adds its own unique identifier code to the identifiers contained in the identity instrument and transmits same as identified by item 40, to the location as identified by item 34, from which it will receive a simple “yes” or “no” response indicating that the object of value identified by the identity device as illustrated in item 35 is or is not currently insured. To continue with the previous example, the access device would incorporate GPRS, CDMA, Mobitext, GSM, CDMA or other communications platform and technologies, and access either the central server of the present invention, illustrated in FIG. 2 as item 33, or an exact copy of same operating as a node or as an additional “clone” server inside a government “DMZ” in an intranet environment. If we use the vehicle insurance example, it may only be that a law enforcement officer “runs the plates”, prior to first leaving his or her vehicle at a traffic stop or accident, whereupon the DMV and/or law enforcement central server will provide an auto query to the previously referenced dedicated node, typically on a DMV server or accessed via intranet and located in a government “DMZ”, which contains the identical information as that stored in item 33 at any time, and receive via this means, totally accurate data regarding vehicle insurance status. The exceptionally small file size being maintained by the present invention further ensures a very rapid response to any such query.

Many other technologies regarding identity cards and readers, (which would include digital watermarks, one and multi-dimensional bar codes, magnetic strip and text readers), can be utilized, although it may be argued that memory cards are generally agreed to be a superior alternative regarding both cost and certainly provide superior security. In any case, no aspect of that prior art forms the basis for claims of the present invention.

As illustrated by item 41, which begins “Module J”; other devices capable of query include computers using the internet, PDAs (Personal Digital Assistants), using any one of many different communications technologies, (including those listed in [0120] above), and other, similar devices, including telephones, all of which can be used to query status by transmitting the “UC”, (as illustrated by item 42), along with identification codes and headers, to the location as indicated by item 34, and receiving status information in return by the same route.

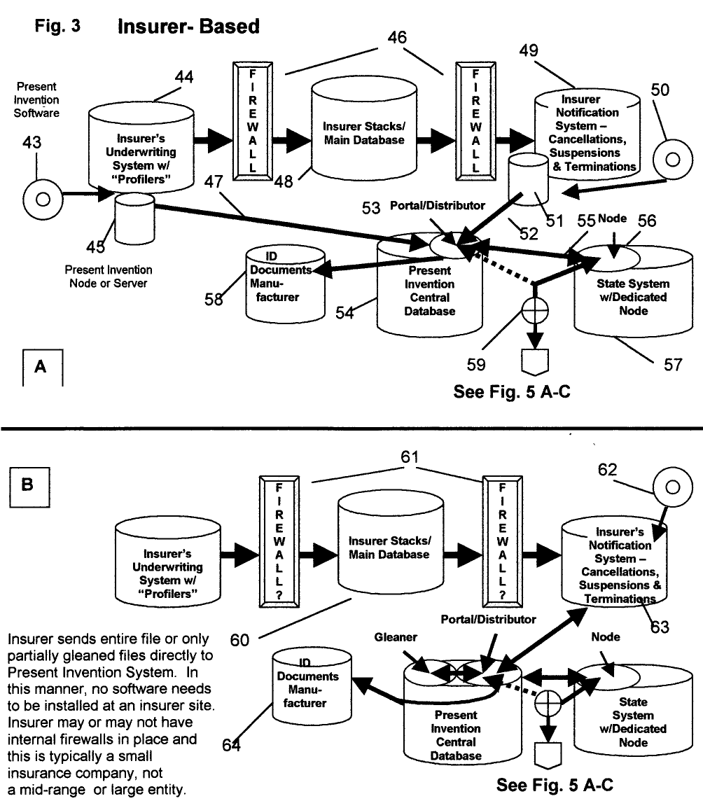

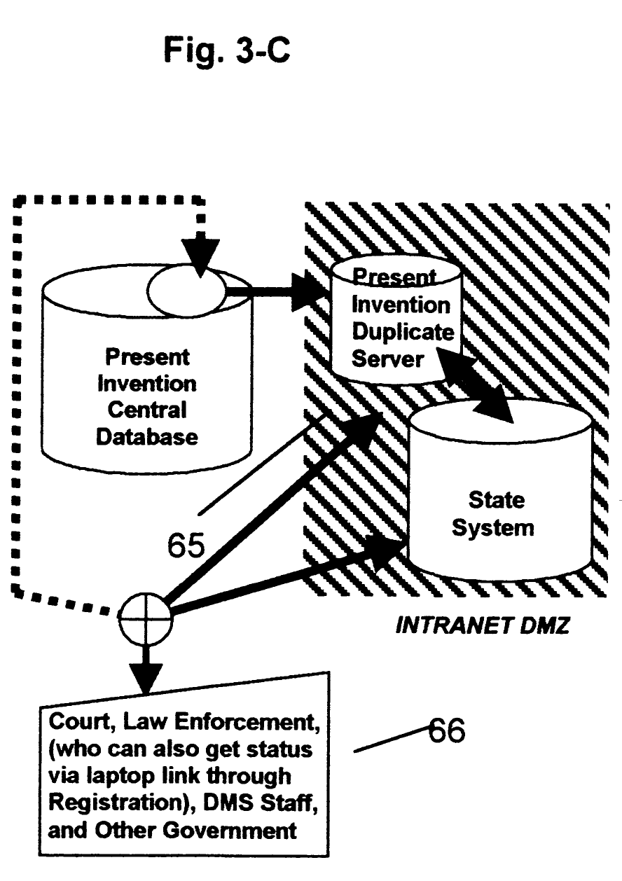

FIG. 3 begins with item 43. This item represents the present invention's proprietary “gleaner” technology based on fextraction and is another view of FIG. 1, beginning with item number 1 and is also referenced as “Module A”. Likewise, item 45 is either the server or node typically used for underwriting by the insurer or it is a separate server used to spool underwriting results to, which then handles the gleaning (file field extraction), functions on files that are approved and which also then assigns the “UC”. It additionally makes the “UC” available for use by the insurer, as was previously illustrated by item 6, and transmits all “gleaned” (data elements which have been extracted from files), data to the “Insurer Distribution Module”, seen previously as item 25, (or “Module D”). This is also known as the “FEG” or “Front End Gleaner”.

Item 44 represents the insurer's main underwriting server, which is typically a separate system, isolated by firewalls, (item 46), from the insurer's “stacks” or main database, seen here as item 48. Note that the insurer's main database is also typically secured from the insurer's own reporting system, (item 49), by a firewall, (again referred to as item 46). Item 47 represents the transmission of data, still inside the insurer's system and passing no firewalls, to the additional server or module, (item 51), that keeps the results of item 43 in memory and transmits, (“publishes”) it to the dedicated database. It typically also handles reporting of the file extractions from this “REG” or “Rear End Gleaner” as referred to as items 50 and 51, because item 50 is the present invention software supplied that makes all this possible, (same as Item 43), and item 51 is the actual physical dedicated server or node used by the present invention. In some cases the results or product of the REG may be passed directly out using an existing transmission system, to the dedicated server, just as described for the FEG results above. Item 52 represents the transmission of data to the present invention's central server, (item 54), the portal used by that transmission is seen here as item 53.

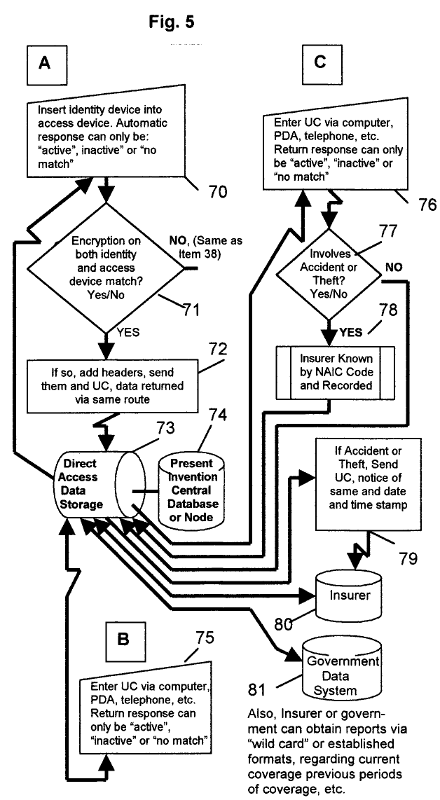

Item 55 indicates the transmission of data obtained by the file extraction process of the present invention, (in accordance with stated requirements for government and/or insurer acceptance and use), directly to the government site involved, (for example, a DMV if these are vehicle files). The portal receiving this data will normally be a node, (item 56), of the government server involved, (item 57). Note also that the same data, (with possibly some additional marketing promotion and accident reporting details, instructions or requests, in support of insurers and their agents), is sent to the company responsible for ID card production and supply, (item 58). Item 59 indicates that the stored data maintained by the present invention is now available for access and use. FIG. 5 further demonstrates this.

In FIG. 3B, Item 60 represents the same as item 48 previously, (the insurer's central database), but note that much else is now missing as compared with FIG. 3A. This configuration would be typical of a very small insurer with low volume and without a more sophisticated separation of internal IT, (Information Technology) elements. Such an insurer may be forced to operate on a single server and merely partition between underwriting, database maintenance and reporting functions. Such an insurer may not have adequate firewalls between these elements of their IT system, (seen here as item 61). The present invention allows each insurer to utilize the level of features they are most comfortable with and can best use given their system. If the insurer in question has what they believe to be adequate internal firewall protection, and wishes to do so, they can choose to use a more limited version of the present invention software, (item 62). The software level of features available never changes but the selections of options remains table-driven and under the control of insurer. As an alternative, they can simply send, directly from their reporting server, sub-system or node, (item 63), entire files of policy initiations and also all suspensions, terminations and cancellations, to the present invention's central computer system. There, all data is “gleaned”, (file field extraction), has a randomly-assigned UC added to each combination of policy and object of value identification number, (VIN, manufacturer or distributor's ID, as previously described, or to two other elements as directed by insurer and/or governmental entity), and is returned to the present invention's portal where it is then sent to the company handling Identification documentation production, (if required, and illustrated as item 64), to the government system, (typically to a node of the present invention resident there) and, along with confirmations, etc., to the insurer involved. The procedure described happens almost instantaneously because decisions are made by first identifying, (by means of the NAIC-assigned five digit insurer identification number), the insurer involved and then initiating actions, (field extractions) based only on the previously established choices of same. Given the very limited level of these requirements, this requires very little processing and hence, no real delay.

In FIG. 3C, is seen the sole alternative to the present invention's insurer-based supply of data to the government database. Increasingly, governments are choosing to simply utilize a separate server (item 65), inside a government-controlled “DMZ” so as to establish an intranet. This has several advantages over the alternative seen in 3A and 3B, including the ease of implementation, (other than linking to APIs, there is almost no implementation required), and the additional safety inherent in such a system. Additionally, as big State systems have a poor history of availability, this configuration, with its automatic back up by the present invention's central database, ensures that law enforcement, the courts, and other government agencies can always at least get insurance status, (item 66).

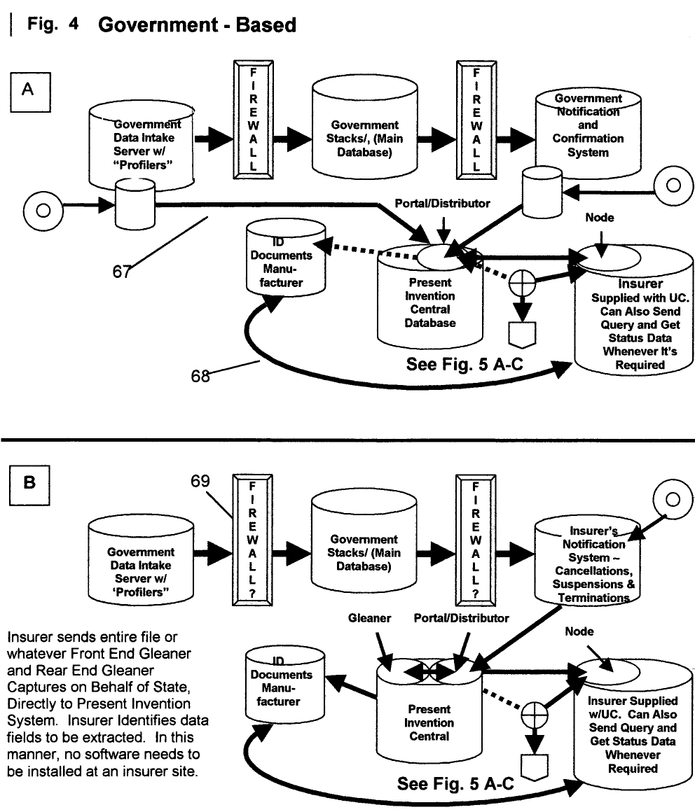

FIG. 4 represents the present invention in operation at a government site (illustrated generally as item 67), rather than at an insurer site, however, while terms and elements may change slightly, the claimed features of the present invention remain identical. Instead of policy initiations, this system's intake is insurer files and the UC is assigned to either the same combination used by an insurer, (just as in FIG. 3), or to at lease two other elements chosen by the government involved. The report element of this system, like that of the insurer version in FIG. 3, is composed of “notices of terminations, suspensions and cancellations”. In this scenario, note also that there may be advantages in direct communication, (at least in regards to the UC assigned), between insurer and insurance identification documentation manufacturer, and that is illustrated as item 68.

FIG. 4B, and identified generally as item 69, should be viewed in relationship to both FIG. 4A and FIG. 3B. It is simply the same as 3B with the previously referenced changes discussed in 4A.

FIG. 5 illustrates access to the present invention's data.

Item 70 begins the first method mehod, (Module A), which involves secure device access. This might be a “smart card” and related “smart card” reader, a “chip card”, (memory only chip-based ID technology), and related reader, a bar code element and related device, or any other ID and related reader device that provides additional security. Item 71 illustrates the decision then made by the reader device regarding the legitimacy of the ID card or similar device. If the encryption does not match, then the ID device is rejected and, as illustrated by item 38 previously, the process ends. If it matches, the process continues and the reader then adds additional headers, (illustrated by item 72), to identify itself to the system, and sends that plus the unique identifier, or unique code, (the “UC”), to the present invention's interface, (item 73), to its central server, (item 74), or to the present invention's node at a government site as described previously and which contains the exact same data. The result of the query, (which will be one of three responses: insurance policy on this vehicle is “active”, insurance policy is “inactive”, or “there is no record of insurance”, will be returned immediately to the reader identified as item 70.

Module B is identified as item 75 and is simply the use of an interactive device that might be a telephone, PDA, computer using a simple web interface or similar, having connectivity and direct access to the interface, (item 73) for the present invention″s database(s). Because the present invention maintains no names, addresses, or any other details of a personal nature or commercial value, and the entry and retrieval is so limited, this is totally safe and non-invasive.

Module C, which begins with item 76, is almost identical to the procedure described previously and illustrated by item 75 that the user is first asked if the query relates to an accident, emergency or theft, (item 77). If the user indicates a negative response, then the process continues exactly as it did in Module B, (item 5). If the user indicates a positive response, and an electronic reading device is in use, and the ID card of other identification document has in memory or symbols, the relevant NAIC code, that confirmation is instantly recorded along with the NAIC code, (item 78). This code identifying this insurer is thus already included in the data stream and is used as a header for access to data and also for records that might be accessed and used by insurers and/or governments, (as identified by item 80), at a later time. Note that the query continues to item 73, representing access to the present invention's stored data. If this is a telephone, wireless, internet or other type of query, then the NAIC code is obtained by reference to the UC as all UCs are matched to specific insurer NAIC codes when assigned as a block for insurer use. In either case, if a positive response to the query regarding accident, theft, or other emergency is obtained, then the notification of accident or theft report along with the UC is transmitted automatically to the insurer involved.

Item 79 represents the present invention's automatic forwarding of the indication that an accident or theft has occurred along with the UC involved which identifies the actual policy so that the insurer involved may be quickly informed and enabled to take action to assist the policyholder and perhaps mitigate risk rearding potential losses. This additional feature is of very great benefit to insurers and policyholders. Likewise, the present invention provides APIs to all government entities involved so that they may choose to further link their system server to that of the present invention in order that an accident report filed later by law enforcement automatically sends the UC involved and a code representing the fact that an accident has occurred automatically, to it. This further enables the present invention's server to automatically provide it to insurer involved.

Item 80 represents the insurer data system and item 81 represents the government data system. Note that items 80 and also illustrate the ability to query the present invention database and obtain both status, (exactly as described by item 75), and reports based on the limited data maintained.

FIG. 6 begins to detail the third and last section of the illustrative embodiments, which is actually a more detailed description of one element, (“gleaning” or file field extraction and related routines), of the art identified in FIGS. 1 through 4.

The present invention is illustrated with reference to data streams, consisting of inbound file initialization and outbound report or “statement” streams common to insurance and especially to vehicle insurers. Additionally, the files accessed may or may not be in “live” files, but in a database other than the insurer″ s “stacks” or central database. In many cases, this may be archived data. The gleaning process, (file field extraction), operates in that case in exactly the same manner. This is applicable to both insurer and government systems dealing with insurance data. No distinction is made herein between an initialized (accepted) insurer file, (which could actually be a new policy, any addition to a policy, or a “reinstatement” or in the case of a government server, an approved file from an insurer that had been submitted for processing. To the present invention, these “inbound” data streams or files are all exactly the same. Likewise, no distinction is made, regardless of where initiated, between a “statement”, “printed report” or “report”. To the present invention, these “outbound” data streams or files are also all exactly the same. Additionally, with few exceptions, both groups of data streams, (“inbound” data streams or “outbound” data streams) or “add” files and “report/outbound” files are the same. How, when, and where they are processed is decided by others using the present invention's features.

There are three common methods available for performing the tasks regarding file field extraction. All are prior art but the of the “UC” and other aspects of the present invention make their usage in matters of insurance verification unique. One or more may be used by the present invention in a single site. Extraction software based on recognition of identifiable characteristics, often called Parametric Information Extraction, or “PIE” is well-documented in prior art by such patents as U.S. Pat. No. 4,965,763 to Zamora. Additionally, these tasks can also be accomplished by Print/Report Stream File Field Extraction, using knowledge of common print languages, print positions on report pages, etc. The most common method also remains the simplest: the use of a table-driven software routine to indicate exactly where in the data stream or file a certain field will be found and what constitutes, in that field, a proper population of same, after which, file field extraction is handled automatically.

FIG. 6 provides a general overview of the manner in which a data stream is processed according to the present invention using Print/Report Stream File Field Extraction, and specifically illustrates a production data stream and a sample data stream. The production data stream may be in the form of an approved file initiation, (often referred to as an “add”), or, if dealing with a suspension, termination, or cancellation notice, it would be a statement, print or report stream, (all of which are identified and handled as the same by this present invention). The example used in this instance, is of the type that would be sent to a printer for printing an “inactive” notice, and this version is very typical of the “Print/Report Stream File Field Extraction” version. It may come directly from the document-processing computer that generates the print stream in the first instance, or it may come from a special report server or node, which has been instructed by the computer providing the instruction to print this document. In any case, such a print/report data stream would generally carry printer code for printing a plurality of reports that may have a number of different report formats.

For example, in insurance operations, the production print data stream may contain the requisite coded information for a batch of policy account statements to be forwarded to policyholders, notification letters for upcoming expirations, as well as internal financial reports for the insurer's use; it may also or instead, contain coded information for printing a batch of reports all having the same report format. The sample print data stream is a smaller print data stream containing representative reports for use in devising data extraction templates as explained below. In the case of new “adds”, (approved policies, policy additions, or accepted files if a government site is involved), the procedure is exactly the same, and only the terms, “add” or “initiation” instead of “print” or “report” actually change.

The data stream is simply, (and always), a binary data stream of the type sent to either initialize a file in a database, (but is read prior to passing a firewall and doing so), or to a printer to produce printed statements and reports. The present invention may read the same in a database, but they have first been passed to same by the means described above. The binary data stream encompasses the informational content to be reported as well as formatting codes and file and/or printer control codes. The present invention only seeks data that is very limited, which never includes bit-mapped image data or anything other than very small file elements. The data stream involved, may, however, contain a large volume of additional data unnecessary to the present invention and which must be ignored. The term, “report data stream”, is used broadly herein to refer to a sequence of coded information of the type to be sent either to a database as an approved file or to a printer to issue a notification regarding suspensions, terminations, or cancellations. The term may include an entire sequence to be sent in one or more jobs, and it may include only a portion of a sequence to be sent.

Insurers use underwriting systems and central databases of many different types, but they all share commonality in regards to the use of profilers, and “price and place” elements. Likewise, governments accepting insurer-supplied data operate in an almost identical, (but slightly simpler), manner by first determining that certain fields are present and key elements are provided, prior to processing. The present invention's use of XML and similar “agnostic” software ensures that the differences involved are of little or no consequence, as it simply first verifies that the required fields in the data stream are present and properly populated, then handles field extraction. The assignment of a Unique Code to two elements previously determined by the system user, spools the results, and later publishes, (transmits) same.

Insurers are required by legislation and/or regulation in many States, Provinces and other jurisdictions to provide notifications to both policyholders and government entities responsible for monitoring compliance with mandatory insurance coverage. Over time, insurers have increasingly determined that the benefits to both their profitability and to their policyholders is enhanced by providing these notices and typically provide such notifications to governments and policyholders even in jurisdictions where they are not required to do so. The absence of uniformity in required reports has however, created severe logistical and resource concerns for insurers. The present invention entirely resolves those issues and concerns.

While all requirements can be easily handled by the aforementioned art, it is important to remember that there are three different method available from prior art to handle these needs. FIG. 6, while exemplary to the present invention generally, is somewhat more specific to the use of extractions from print/repot data streams. Print/report data streams are often written in one of several established languages, sometimes referred to as page description languages. Consequently, the previously described ability of the present invention's XML-based features in Underwriting or Government data intake, would not be used if extraction from print/report data stream using a page description language was used instead, not because it would fail in that task, but simply because only one of the three demonstrated methods are required, (although more than one method might be used by a single insurer elsewhere as they often have multiple sites). Examples of such types of print/report data streams include ASCII, several generations of the PCL language from Hewlett-Packard, the PostScript language from Adobe Systems, Inc., and the Advanced Function Presentation or AFP language from IBM. A large enterprise-wide computer system will generally include numerous printers sometimes requiring report/print data streams of different types, and the data stream originating at any given time in any given department of the enterprise may thus be one of several different types. While not the preferred embodiment, this method might be determined as more advantageous for an insurer or government, and is thus noted as the present invention remains unaffected by such methods.

Each report in an individual report data stream will have associated with it a report type, which indicates, for example, whether the report is a billing notice, an offer of additional services, a thirty day warning prior to termination, special notices regarding types of insurance, (PIP, SR-22, SR-26, etc.), or n official suspension, termination, or cancellation; it could also be an internal activity report or some other category of report. Each report will include a number of fields for presenting information, such as policy number, date, VIN number, zip code of the policyholder, and much more. In addition, each report type may be revised from time to time to change the layout of the report or to add further content-bearing fields. Thus, each report type will have associated with it one or more versions as such modifications to the report format take place. The format of a printed report, (that is, the format of a report in the report data stream), will be determined once the report type and version are specified.

In the past, to retrieve selected data, such as the policy numbers for all reports in the report data stream, it has generally been necessary to hard-code the input software with the location of the each policy number so that the input software will know where in the report data stream to find the policy number information. With the methods of the present invention, selected data may be retrieved from a data stream, even after the formats are revised and new data fields are added, without revising any computer software code. As described below, an operator having no technical computer expertise or knowledge of programming may update the system to account for modified or entirely new file or report formats. This is achieved in the case of the print/report data stream extraction method, part by providing an extraction database (item 82), containing file or report format information for each of the file or report formats in use. The extraction database may be maintained and manipulated by a business user through a graphical user interface or menu system at a display terminal.

While this documents the present invention's ability to accommodate such needs, it should be remembered that a far more subset of these features is actually provided to an end user, (governmental entity or insurer), along with a GUI. This accomplishes two things: it ensures that changes will be accomplished in minutes, rather than hours by an even more unskilled operator than that enabled by the full features of the present invention, and it further ensures that the insurer and/or government entity involved maintains control over what can be changed, and how those changes can occur. In effect, an additional layer of control and “direction” is added.

A description is now given of the manner in which a production file or report data stream is analyzed and processed. As indicated at block/item 83, the production file or report data steam is first analyzed to determine the data stream type, and in the case of a report or print data stream, it is assumed that this might involve the type of printer language used, thus this instance is fully described.

Continuing, and now assuming, (to assure a “most difficult case” scenario), that the present invention is using page description language, it must then be analyzed at the block identified as item 84 to determine the report type and the report version of the first report. First, the beginning of a first report in the report data stream is found. Methods for locating the beginning of reports or other file in a report, (in this case, also the “print data stream”), are well known and are prior art. Typically, the data stream will contain a code indicating the beginning of each report, or alternatively an algorithm may be applied to the report data stream to determine report beginnings.

Each report will typically be preceded by a file in the form of a header or a sequence of coded fields including data in the report type, which data may be found at a characteristic location in the header or sequence and so may be determined easily and automatically.

Thereport version can also be determined either directly or indirectly from the report data stream. The report version may be directly encoded in the report header or in coded fields and may be retrieved directly along with the report type. Alternatively, the report may include other indicia from which the report version may be derived. For example, a report will typically include a standard State code, (such as CA, GA, or IL), or alternatively a code representing a specific Province or other jurisdiction. Where only one version of the report format is operative at a time, that is, different versions of the report format are not in use during the State reporting range, the report date or time may be used to effectively identify the report version. In this case, the report format information stored in the extraction database for this report type will associate each version with its operative date or date and time range. The print data stream is analyzed for the report date or time, which is compared with the date or date and time ranges included in the report format information for the given report type to find the report version. The manner of carrying out such comparisons is routine and need not be disclosed in detail here.

The addition of time frames instead of just dates may be valuable since that information may be utilized to further evaluate and choose files. It is generally assumed that reporting will be at least daily, but may be far more frequent, (in fact, some large insurers will doubtless use an “open pipe” for continuous and so all files for a given date, will normally (at the very least) be transmitted that same day, or in the early hours of the following day. It is common practice for insurers to bind coverage automatically for at least a twenty-four hour period which, with at least daily reporting, means that the present invention delivers accurate status information at all times. Likewise, if reporting may not be daily, but the binders used still cover the period, the system's information remains current and totally accurate in any case.

As indicated above, the extraction database (item 82), contains report format information for each of the report formats that can arise in the report data stream. The report format information for a given report format includes a report type, a report version, and at least two extractable fields. By extractable field is meant a content-bearing field that is present in the report format, the content of which a user may desire to extract from the report data stream. The extractable fields in the database are the fields of data that the present invention makes available to be extracted from the report data stream. In general, a plurality of extractable fields will be defined for each report format. These features are the same for all initiation, (“adds”) files as well.

Each extractable field is provided, (reported or printed), at a prescribed position in the corresponding report format, that is, in the corresponding version of a given report type. The field position may be a fixed position on the viewed or printed page, (for example, a date field that is centered a set distance fom the te top of the page). In this case XY coordinates on the report page may specify the position for example. Alternatively, the field position may be specified as a relative position, for example, notification text that appears at prescribed coordinates with respect to the last entry in a column with a variable number of transactions. The report format information in the extraction database associates a field position with each extractable field indicating the position at which the extractable field is reported and/or printed in the corresponding report format. Again, these features are common with “adds” in Underwriting or in Government intake systems in which only the terms change, (“report” changes to “add” or “initiation”, for example).

Once the report type in the report data stream is known, the report format information can be retrieved from the extraction database and the version determined. Each extractable field identified in the report format information for the given report type and version may then be sought in the report data stream. This is achieved by searching the report data stream for report/printer code for printing or reporting a data field at the position associated with the desired extractable field in the retrieved report format information. As an example of a field printed at a fixed location, consider a date field beginning at given XY coordinates in the printed report, then the date field may be sought in the data stream by searching for appropriate printer code that causes a field to be printed at the prescribed XY coordinates. The content of that field, that is, the information to be printed beginning at the prescribed XY coordinates, is then extracted (see block/item 85), and the system proceeds to search for the next desired extractable field.

If, at some time the report format is revised so that a specific field appears at a different location on the page specified by new XY coordinates or perhaps now specified as a relative position, then it is only necessary to revise the report/print position entry for this field in the extraction database for the given report type and version. Similarly, if the format is revised to include new data fields, or if it is desired to search for and extract data fields that had not previously been designated, it is only necessary to add the fields with their associated print/report positions to the extraction database. This invention provides a convenient method for accomplishing this.

To define or update the extraction database, a sample data stream is presented to an extraction setup module (item 86). The sample print/report data stream comprises a data stream for a sample report or for several sample reports of different formats if more than one report format is to be added or updated in one session. The extraction setup module (item 86), searches the sample print/report data stream for all fields in the sample report (or in the first sample report if more than one report is included) in the same way as above by looking for print commands in the print data stream. Such fields constitute candidate fields for possible inclusion in the extraction database. The candidate fields are presented on a display monitor through a graphical user interface or through a menu system.

The user then selects the fields to be included in the extraction database. Means by which a user can enter a selection are well known to designers of user interfaces for display terminals and need not be described in detail here. The user can also be given an opportunity to name the selected extractable fields. The selected field or fields are then stored together with their associated characteristic print positions (which are known from the sample print data stream) as extractable fields associated with the sample report format. These functions are currently handled by the supplier of the present invention, which in turn supplies the GUI to end users of present invention as their means to make choices and, through these choices, effect the required or desired modifications.

A description is now given of the manner in which the information in a report is organized for use in the present data extraction system. The information in a report of any given report type is organized according to a hierarchy of sections and groups. Each report type can have multiple sections. Each section can have multiple groups, and each group can have multiple subgroups. A group may be repeatable, meaning that the same group structure is repeated sequentially in the document as many times as needed to display the relevant data. The data displayed in a group appears in fields, and a group may have any number of fields. A section is a logical object that provides for the presentation of data in multiple columns. A section represents a list of physical pages having the same columnar layout, that is, one-column pages, two-column pages, etc.

The signature will generally involve a character string appearing in a group, although it may not be an extractable field. The signature takes the form of a prescribed alphabetic, alphanumeric or other character string or a pattern of characters. The signature may also include coordinate locations, (absolute or relative), for the start of the signature or may be defined by a combination of coordinates, character strings, pattern matching, or even font identification. In general, the definition of signatures is intended to be flexible and thus may include other distinguishing characteristics such as font type.

Within each group there are at least one and typically a number of extractable fields. These fields are defined by their location relative to the group signature. Thus, to find a desired extractable field in a data stream it is only necessary to know the group to which the field belongs, to find the group signature in the data stream, and to then go to the desired field's location relative to the group signature.

To extract a selected field from a print/report data stream, the following preparatory steps are required: First, the print/report data stream is parsed to find the boundaries of all the reports in the data stream. This is a straightforward task in the illustrated embodiment because each report begins with a “Begin Document” tag and ends with an “End Document” tag. Each report is then parsed to find each page of every report and each extractable field on each page. In the illustrated embodiment “Begin Page” delineates the pages of a report and End Page denotes the end of each. The fields are found by their coordinate locations relative to the group signature. Methods for parsing AFP data streams are known in the art and AFP parsing software is commercially available.

A table is then compiled of all the extractable fields, with each entry in the table having the format (X, Y, font, content), where X, Y are the coordinates of a standard reference point for the field, for example, the lower left corner of the field. “Font” refers to the font in which the text data appears, and “content” refers to the extractable content of the field. That is to say, an extractable field may include standard headings or other characters.

The extractable fields on each page are then organized in two ways by means of two hash tables. These are referred to as the X-hash table and the Y-hash table, and they sort the extractable fields on a page by their X and Y coordinates, respectively. By pre-sorting the text fields in this way, this technique limits the scope of searching and improves the performance of the information extraction process.

To successfully extract selected data from a print/report data stream according to the present invention, an extraction database is needed that indicates the extractable fields available for each report type in the print/report data stream and specifies expressly or implicitly the print/report positions of those fields The method of the present invention may be utilized, and advantages of the invention may be realized however, no matter how the extraction database is provided.

The extraction database is generated from a sample print/report data stream that contains a master report of a given type. The print/rep data stream is examined to determine the layout of the hierarchical structure of the report in sections and groups and to identify all possible extractable fields in the report. The hierarchical structure is recorded in an internal form that is figuratively referred to as a template for the report type and is used for defining filters by which a non-technical user may select extractable fields to be parsed from a print/report data stream. All the needed information on the hierarchical structure of the report type is included in the report template, which is stored in the extraction database for future use.

Initially, a technical user prepares a template for each version of each report type that might be required. The technical user examines a sample print/report data stream for each report type. This is conveniently performed graphically by displaying the sample report type on a display monitor. The user then identifies the areas of the report that are desired to be sections, groups and fields. For each identified group and section the user identifies an associated signature. Successive signatures define the group and section boundaries. When the user indicates that a group signature is in “fixed position”, the system automatically stores the fixed location in the appropriate attributes of the group object table.

If the group signature is floating, i.e., the location of the group can vary depending on the content of the group, then the user specifies the characteristics of the signature, which will include one coordinate (X or Y), and perhaps the match string or pattern, and another feature, like the font. The specified signature characteristics are automatically entered into the appropriate attributes of the group object definition table. If a group is defined as floating, then all its subgroups and fields are automatically defined to be floating and signatures will have to be defined for all such subgroups and fields. During template definition the user identifies all the fields that are to be extractable. The location of each of these fields is recorded relative to the signature of the group to which the field belongs. These fields will serve as candidate fields that a non-technical user may later choose to select for extraction. The sample report used to define the template is saved with the template.

Once a template for a report type and version has been defined, it may be used for extraction of data from a production print/report data stream. A non-technical user may select data for extraction by defining a filter based on the template, but in all cases these pre-determined template choices are restricted to those authorized by the governmental entity and/or insurer involved. The user selects a report type and version and the system opens a copy of the appropriate, approved template along with the sample report from which the template was generated. The approved extractable fields, groups and sections are presented to the user as candidate fields or areas to be extracted, and the user then selects the areas or individual fields available. The appropriate bits are then automatically set in the corresponding attribute for the object. Methods by which a user may select areas or fields on a graphic display are routine in the art and not discussed in any detail here.

The user will also have the option of specifying an output format for the extracted data. These output formats will be limited by template choices and must conform to previous decisions which are governmental and/or set by the insurer involved. The template corresponding to the user's selections is then saved in he extraction database as a filter for use in the extraction process. The print data/report stream is then examined and parsed using the methods described above to find the fields indicated in the filter, and prepared for distribution, file maintenance, etc. as described earlier.

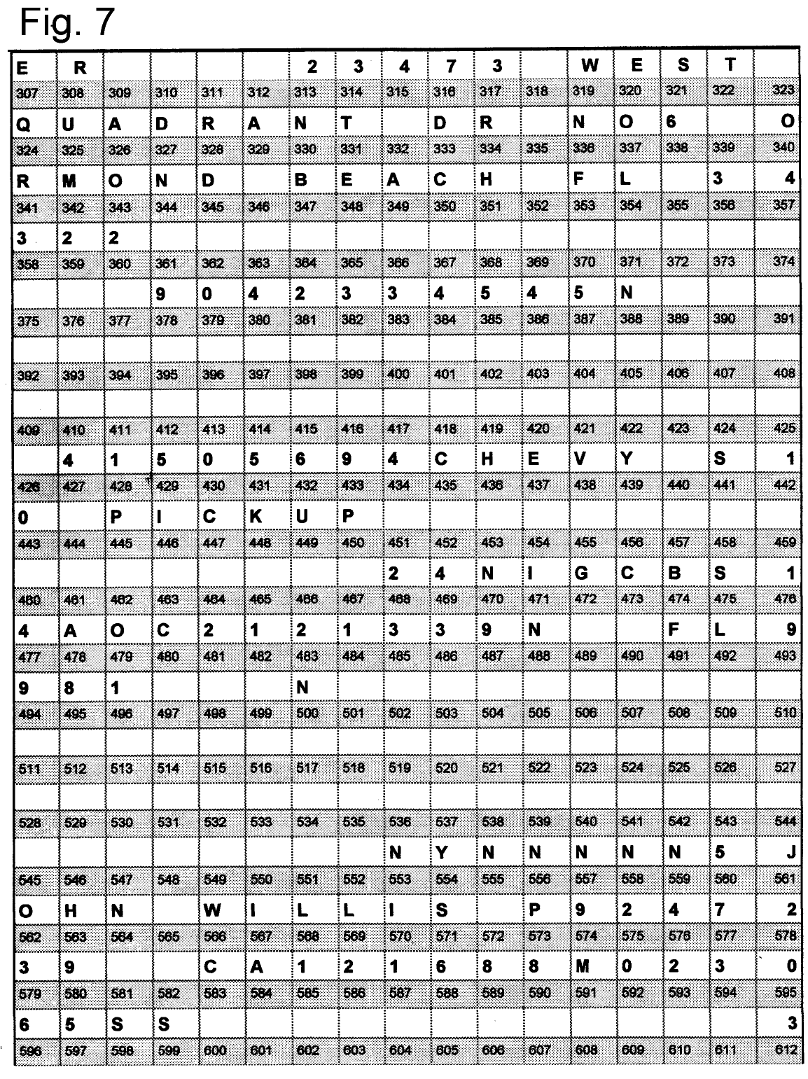

FIG. 7 represents a typical code sheet page from an insurance policy initiation. As discussed previously, the most common method of “gleaning” files, (file field extraction), is also the simplest: the use of a table-driven software routine to indicate exactly where in the data stream or file a certain field will be found and what constitutes, in that field, a proper population of same, after which, file field extraction is handled automatically. FIG. 7 demonstrates a very typical example of how data streams are documented in the insurance industry. On this page, it can be noted that in block 313, an address begins and it is possible that this “address block” ends with block 377. On the other hand, it may be that, given that the “zip code” is seen in blocks 356-360, that block 360 is the last element, (very last available block), of the “address block” or “address section”.

FIG. 7 appears to be a representative code sheet from a vehicle insurance policy, but that may not be the case. It is common to list assets on other applications for various forms of insurance, including a vehicle or perhaps numerous vehicles.

As discussed previously, these matters and concerns are very easily handled. A GUI is utilized to access a table-driven “set-up” routine is a common interface tool well documented in prior art. Using the example of a vehicle policy, (but remembering that this could be any type of policy), the user is asked what constitutes a “vehicle policy”. This is to ensure that the system properly recognizes the type sought since there are numerous types of polices and a particular company may have “mixed traffic”, (polices of various types “in-bound” and “out-bound”). The system's decisions are assisted by that information but other identifiers are also used to determine if a section contains, for example, a VIN, (“Vehicle Identification Number”). If this is an example of the system looking for a vehicle policy and therefore, first looking for a VIN, it has been programmed to recognize the formats containing seventeen characters, (or nine characters if a vehicle produced prior to 1980), and thus, knows that it is dealing with an actual vehicle. These software requirements are prior art and readily available from commercial sources. The present invention has indeed, used this element, and obtained from others, for years.

The system must know with certainty, if it uses the most common method described above, what actual locations in a data/report stream that the VIN, approval code, and other required elements will utilize. The system must also be instructed what actually constitutes an approval code, etc. If block 1037 is normally used for an approval code, but may in certain circumstances, be used for something else regarding a vehicle policy, (assuming once again that a vehicle policy is discussed), then the actual number(s), letter(s) or other symbols that represent an approval code, must be known and recorded, along with the block or blocks representing location of same.

The descriptions and drawings in this document disclose illustrative embodiments of the invention. Given the benefit of these disclosures, those skilled in the art will appreciate that various modifications, alternate constructions, and equivalents may also be employed to achieve the advantages of the invention.

1. It is claimed that this present invention is a computer implemented method for accurately determining the presence or absence of insurance on an object of value comprising the first step of data extraction at insurer site or other site on behalf of insurer and transmission of said extracted data to a dedicated database for maintenance of same. A) The method of claim 1, wherein, A software system supplied to insurers provides a method of extracting selected data fields from a data stream or data base, said data stream or data base including code for providing a plurality of reports having at least one of a plurality of report formats, said method comprising the steps of: i.) providing an extraction database including report format information for at least one of said plurality of report formats, said report format information comprising at least two extractable fields of which one represents current status, having a data position associated therewith indicating the position at which said at least two extractable fields are provided in the corresponding report format; ii.) presenting a data stream or file, which may be a file data stream or file or a report (print) data stream or file; iii.) analyzing said presented data stream or file for the presence of a first report having a first report format; iv.) retrieving from said extraction database the report format information associated with said first report format; v.) searching said data stream or file for a data field to be reported or printed at the report or print position associated with said at least two extractable fields in the retrieved report format information; and vi.) extracting the contents of said data fields; vii.) whereby the data fields available to be extracted from said data stream or file may be updated by updating said extraction database. B) The method of claim 1, wherein, i.) said report format information comprises a plurality of extractable fields and associated field positions, and, ii.) said method further comprises the steps of selecting at least two extractable fields, of which one represents current status, from said plurality of extractable fields, and, iii.) said searching step comprises searching said data stream or database file for data fields to be reported at the position associated with the selected extractable fields. C) The method of claim 1, wherein, i.) each of said plurality of reports has a report type and a report version and, ii.) said report format information further comprises a report type having associated therewith at least one report version, said method comprising the sub steps of: a.) analyzing said presented data stream or file for the report type and the report version of said first report; and, b.) retrieving from said extraction database said report field position of said at least two extractable fields, of which one represents current status, associated with the report type and report version of said first report. D) The method of claim 1, wherein said data stream or file includes at least two data field types, and, said method further includes the step of identifying at least two data field types in said presented data stream or database file. E) The method of claim 1, wherein a method of defining an extraction database for use in extracting selected data fields from a data stream or database file, said data stream or database file including report code for reporting a plurality of reports having at least one of a plurality of report formats, said method comprising the steps of: i.) presenting a sample data stream or database file including report code for a sample report having a sample report format, said sample report format including fields at characteristic report or print positions; ii.) searching said sample data stream or database file for all fields to be reported in said sample report; iii.) presenting said fields on a display monitor as candidate fields for inclusion in said extraction database; iv.) providing means for a user to select at least two of said candidate fields as extractable fields; v.) storing the at least two candidate fields selected by the user together with the associated characteristic report position as an extractable field associated with said sample report format, thereby to form said extraction database. F) The method of claim 1, wherein a method of preparing a document for data extraction is provided comprising the steps of: i.) identifying in said document a plurality of groups of data; ii.) assigning a characteristic signature to each group of said plurality; iii.) recording the position of each said signature; iv.) identifying at least two extractable fields in each said group; and v.) recording the position of each said extractable field relative to the signature of the respective group containing each said extractable field. G) The method of claim 1, which will be one or more of three prior art methods, to wit: parametric information extraction, (known as “PIE”, and perhaps best seen in prior art including U.S. Pat. No. 4,965,763 to Zamora), or extraction from fixed-file positions if populated, and if data meets pre-established requirements, (and is described in more detail in Illustrative Embodiments in this document), and/or Print/Report Stream File Extraction, wherein a method of locating a floating field in a data stream or database is provided, said floating field having a first fixed coordinate and floating in a second coordinate, comprising the steps of: i.) parsing said report data stream to find the coordinates of all text data fields included therein; ii.) partitioning the X and Y-axes of each element, section or page in said report data stream into intervals; iii.) defining an X-hash table and a Y-hash table for each element, section or page in said data stream, said X-hash table including cells corresponding to said X-axis partitions and said Y-hash table including cells corresponding to said Y-axis partitions; iv.) assigning each said text data field on a file page to the X-hash table and Y-hash table for the file page based on the cells containing the X and Y coordinates of said data field; v.) identifying the cell containing said fixed coordinate of said floating field; and vi.) searching only said identified cell for said floating field. H) The methods of the above referenced claims, 1., A, through G., wherein this process occurs in insurance underwriting, at least two of the previously referenced extracted fields, one of which represents current status, predetermined by insurer and/or governmental regulation, shall be randomly assigned a random unique identifier (also assigned at random), from a pool of available random unique identifiers provided to said insurer and located in the extraction database. i.) This unique identifier, (to be referred to as the “UC” or “Unique Code” and it is a unique identifier that will never be reused), to then be recorded, as an individual file, which will also include these and other extracted fields regarding this transaction, in the first of two extraction databases. ii.) This process and the subsequent files collected to be referred to as “FEG” or “Front End Gleaner”. iii.) Said files to be published at a time chosen by insurer and/or governmental entity with regulatory authority, to the dedicated database for later access as discussed in claim 5., following. I) The methods of the above referenced claims, 1. A through G, wherein this process occurs in insurance notification reporting and at least two or more extracted fields, predetermined by insurer and/or governmental jurisdiction, but in all cases, one of which shall be a “suspension”, a “termination” or a “cancellation” status notification, (any of which are referred to as a “deactivation”), and one of which shall be either the policy number, the manufacturer's identification number or the UC, shall be extracted and recorded as a separate file in this second extraction database. i.) This process and the results of said process, (the extracted files), shall be referred to as the “REG”, or “Rear End Gleaner”. ii.) Said files, and also files from “FEG” or “Front End Gleaner” as referenced above in 1. A through G, to be published at a time chosen by insurer and/or governmental entity with regulatory authority to the dedicated database mentioned elsewhere in these claims, (Abstract and elsewhere), by the same means and processes as said insurer currently utilizes now for required government reporting or by similar methods of insurer's choice, including, but not limited to FTP, x.12, x.25 and similar electronic means and methods, to the previously referenced dedicated database. J) The methods of the above referenced claims, 1. A through I), wherein any and all process sites for insurer data remains at discretion of said insurer, provided such site has the system software provided by the present invention. i.) Likewise, insurer, except for specific government regulated requirements, and the automatic assignment of unique identifier, maintains total control over the software, and, ii.) insurer can activate or deactivate any automated element, and, iii.) insurer can operate any element in a manual mode at will, and, iv.) can choose to send files to dedicated database referenced in 2., below or to a government entity by choice or requirement. In all cases, the present invention will extract data fields, assign unique identifiers, record suspensions, terminations and cancellations, and provide both reporting and access for same in the manner described previously in 1. A through I, except that the FEG and REG functions are combined. The present invention is not limited to use in any particular site or type of site but is applicable to all types of reporting regarding insurance status.

2. It is claimed that this present invention is a computer implemented method for accurately determining the presence or absence of insurance on an object of value comprising the first step of data extraction at government site responsible for intake, initial processing, maintenance, and reporting of registration data, and transmission of said extracted data to dedicated database for maintenance of same: A) The method of claim 2, wherein, A software system supplied to government entity provides a method of extracting selected data fields from a data stream or database, said data stream or database including code for providing a plurality of reports having at least one of a plurality of report formats, said method comprising the steps of: i.) providing an extraction database including report format information for at least one of said plurality of report formats, said report format information comprising at least two extractable fields having a data position associated therewith indicating the position at which said at least two extractable fields are provided in the corresponding report format; ii.) presenting a data stream, which may be a file data stream or a print data stream; iii.) analyzing said presented data stream for the presence of a first report having a first report format; iv.) retrieving from said extraction database the report format information associated with said first report format; v.) searching said data stream or database for a data field to be reported or printed at the report or print position associated with said at least two extractable fields in the retrieved report format information; and vi.) extracting the contents of said data fields; vii.) whereby the data fields available to be extracted from said data stream or database may be updated by updating said extraction database. B) The method of claim 2, wherein, i.) said report format information comprises a plurality of extractable fields and associated field positions, and, ii.) said method further comprises the steps of selecting at least two extractable fields, of which one represents current status, from said plurality of extractable fields, and, iii.) said searching step comprises searching said data stream or database for data fields to be reported at the position associated with the selected extractable fields. C) The method of claim 2, wherein, i.) each of said plurality of reports has a report type and a report version and, ii.) said report format information further comprises a report type having associated therewith at least one report version, said method comprising the sub steps of: c.) analyzing said presented data stream or database for the report type and the report version of said first report; and, d.) retrieving from said extraction database said report field position of said at least two extractable fields associated with the report type and report version of said first report. D) The method of claim 2, wherein said data stream or database includes at least two data field types, and, said method further includes the step of identifying at least two data field types in said presented data stream or database. E) The method of claim 2, wherein a method of defining an extraction database for use in extracting selected data fields from a data stream or database, said data stream or database including report code for reporting a plurality of reports having at least one of a plurality of report formats, said method comprising the steps of: i.) presenting a sample data stream including report code for a sample report having a sample report format, said sample report format including fields at characteristic report or print positions; ii.) searching said sample data stream for all fields to be reported in said sample report; iii.) presenting said fields on a display monitor as candidate fields for inclusion in said extraction database; iv.) providing means for a user to select at least two of said candidate fields as extractable fields; v.) storing the at least two candidate fields selected by the user together with the associated characteristic report position as an extractable field associated with said sample report format, thereby to form said extraction database. F) The method of claim 2, wherein a method of preparing a document for data extraction is provided comprising the steps of: i.) identifying in said document a plurality of groups of data; ii.) assigning a characteristic signature to each group of said plurality; iii.) recording the position of each said signature; iv.) identifying at least two extractable fields in each said group; and v.) recording the position of each said extractable field relative to the signature of the respective group containing each said extractable field. G) The method of claim 2, which will be one or more of three prior art methods, to wit: parametric information extraction, (known as “PIE”, and perhaps best seen in prior art including U.S. Pat. No. 4,965,763 to Zamora), or extraction from fixed-file positions if populated, and if data meets pre-established requirements, (as described in more detail in Illustrative Embodiments later), and/or Print/Report Stream File Extraction, wherein a method of locating a floating field in a data stream or database is provided, said floating field having a first fixed coordinate and floating in a second coordinate, comprising the steps of: i.) parsing said report data stream to find the coordinates of all text data fields included therein; ii.) partitioning the X and Y-axes of each element, section or page in said report data stream into intervals; iii.) defining an X-hash table and a Y-hash table for each element, section or page in said data stream, said X-hash table including cells corresponding said X-axis partitions and said Y-hash table including cells corresponding said Y-axis partitions; iv.) assigning each said text data field on a file page to the X-hash table and Y-hash table for the file page based on the cells containing the X and Y coordinates of said data field; v.) identifying the cell containing said fixed coordinate of said floating field; and vi.) searching only said identified cell for said floating field. H) The methods of the above referenced claims, 2., A, through G., wherein this process occurs in governmental intake processing, at least two of the previously referenced extracted fields, predetermined by insurer and/or governmental regulation, shall be randomly assigned a random unique identifier (also assigned at random), from a pool of available random unique identifiers provided to said insurer and located in the extraction database. i.) This unique identifier, (to be referred to as the “UC” or “Unique Code” and it is a unique identifier that will never be reused), to then be recorded, as an individual file, which will also include these and other extracted fields regarding this transaction, in the first of two extraction databases. ii.) This process and the subsequent files collected to be referred to as “FEG” or “Front End Gleaner”. iii.) Said files to be published at a time chosen by insurer and/or governmental entity with regulatory authority, to the present invention's dedicated database discussed in claim 5., following. I) The methods of the above referenced claims, 2. A through G, wherein this process occurs in governmental notification reporting and at least two or more extracted fields, predetermined by insurer and/or governmental jurisdiction, but in all cases, one of which shall be a “suspension”, a “termination” or a “cancellation” status notification, (any of which are referred to as a “deactivation”), and one of which shall be either the registration number, the manufacturer's identification number, the policy number or the UC, shall be extracted and recorded as a separate file in this second extraction database. i.) This process and the results of said process, (the extracted files), shall be referred to as the “REG”, or “Rear End Gleaner”. ii.) Said files, along with files from “FEG” or “Front End Gleaner” as referenced above in 2. A through G, to be published at a time chosen by insurer and/or governmental entity with regulatory authority to the dedicated database mentioned elsewhere in these claims, (Abstract, and elsewhere), by the same means and processes as said government entity uses now or by similar methods of government entity's choice, including, but not limited to FTP, x.12, x.25 and similar electronic means and methods, to the previously referenced dedicated database. J) The methods of the above referenced claims, 2. A through I), wherein any and all process sites for government data remains at discretion of governmental entity, provided such site has the system software of the present invention. i.) Likewise, the government entity involved, except for specific rights typically allowed or granted by government entity to insurer, and the insurer's subsequent choices regarding same, and except for the automatic assignment of unique identifier, maintains total control over the software, and, ii) governmental entity can activate or deactivate any automated element, and, iii.) governmental entity can operate any element in a manual mode at will, and, iv.) governmental entity can choose to send files to dedicated database referenced in 3. and 5., below or to another government entity by choice or requirement. In all cases, the present invention will extract data fields, assign unique identifiers, record suspensions, terminations and cancellations, and provide both reporting and access for same in the manner described previously in 2. A through I, except that the FEG and REG functions are combined. The present invention is not limited to use in any particular site or type of site but is applicable to all types of reporting regarding insurance.

3. It is claimed that this present invention is a computer implemented method for accurately determining the presence or absence of insurance on an object of value comprising the alternative of data extraction and transmission at a site other than that of the insurer or government, but at the direction of either or both, and which is comprised of: A) The method of claim 3, wherein, the electronic receipt of an insurer's or government entity's files directly from said insurer or government entity via FTP or other protocol or method utilized by said insurer or government. B) The method of claim 3, wherein, the use of a software system which both identifies the five digit NAIC, (National Association of Insurers) code, and/or the Federal two character State Code and retrieves from a “look up table”, that specific insurer or government's chosen profile for processing and the maintenance of data according to said insurer's instructions and/or government regulations. C) The method of claim 3, wherein, the “gleaning” of said files in exactly the same manner as described previously in 1., A) through I), above, except that the FEG and REG functions are combined. to wit: i.) The method of claim 3, wherein a software system element is provided which in turn provides a method of extracting selected data fields from a data stream, said data stream including code for providing a plurality of reports having at least one of a plurality of report formats, said method comprising the steps of: a.) providing an extraction database including report format information for at least one of said plurality of report formats, said report format information comprising at least two extractable fields having a data position associated therewith indicating the position at which at least two extractable fields are provided in the corresponding report format; b.) presenting a data stream, which may be a file data stream or a print data stream and may be seen in either an active or inactive, (database) format. c.) analyzing said presented data stream for the presence of a first report having a first report format; d.) retrieving from said extraction database the report format information associated with said first report format; e.) searching said data stream or database for a data field to be reported or printed at the report or print position associated with at least two extractable fields in the retrieved report format information; and f.) extracting the contents of said data fields; g.) whereby the data fields available to be extracted from said data stream may be updated by updating said extraction database. ii.) The method of claim 3, wherein, a.) said report format information comprises a plurality of extractable fields and associated field positions, and, b.) said method further comprises the steps of selecting at least two extractable fields from said plurality of extractable fields, of which one is status and, c.) said searching step comprises searching said data stream or database for data fields to be reported at the position associated with the selected extractable fields. iii.) The method of claim 3, wherein, a.) each of said plurality of reports has a report type and a report version and, b.) said report format information further comprises a report type having associated therewith at least one report version, said method comprising the sub steps of:
analyzing said presented data stream for the report type and the report version of said first report; and,
retrieving from said extraction database said report field position of said at least two extractable fields associated with the report type and report version of said first report. iv.) The method of claim 3, wherein said data stream includes at least two data file or stream field types, and, said method further includes the step of identifying said at least two data stream field types in said presented data stream or file. v.) The method of claim 3, wherein a method of defining an extraction database for use in extracting selected data fields from a data stream or file, said data stream or file including report code for reporting a plurality of reports having at least one of a plurality of report formats, said method comprising the steps of: a.) presenting a sample data stream or file including report code for a sample report having a sample report format, said sample report format including fields at characteristic report or print positions; b.) searching said sample data stream or file for all fields to be reported in said sample report; c.) presenting said fields on a display monitor as candidate fields for inclusion in said extraction database; d.) providing means for a user to select at least two of said candidate fields as extractable fields, of which one is current status; e.) storing the at least two candidate fields selected by the user together with the associated characteristic report position as an extractable field associated with said sample report format, thereby to form said extraction database. vi.) The method of claim 3, wherein, a document of data extraction is created comprising the steps of: a.) identifying in said document a plurality of groups of data; b.) assigning a characteristic signature to each group of said plurality; c.) recording the position of each said signature; d.) identifying at least two extractable fields in each said group of which one is current status and; e.) recording the position of each said extractable field relative to the signature of the respective group containing each said extractable field. vii.) The method of claim 3, which will be one or more of three prior art methods, to wit: parametric information extraction, (known as “PIE”, and perhaps best seen in prior art including U.S. Pat. No. 4,965,763 to Zamora), or extraction from fixed-file positions if populated, and if data meets pre-established requirements, (and as described in more detail in Illustrative Embodiments elsewhere in this document), and/or Print/Report Stream File Extraction, wherein a method of locating a floating field in a data stream or database is provided, said floating field having a first fixed coordinate and floating in a second coordinate, comprising the steps of: a.) parsing said report data stream to find the coordinates of all text data fields included therein; b.) partitioning the X and Y-axes of each element, section or page in said report data stream into intervals; c.) defining an X-hash table and a Y-hash table for each element, section or page in said data stream, said X-hash table including cells corresponding said X-axis partitions and said Y-hash table including cells corresponding said Y-axis partitions; d.) assigning each said text data field on a file page to the X-hash table and Y-hash table for the file page based on the cells containing the X and Y coordinates of said data field; e.) identifying the cell containing said fixed coordinate of said floating field; and f.) searching only said identified cell for said floating field. viii.) The methods of the above referenced claims, 3, A, through G., wherein at least two of the previously referenced extracted fields, predetermined by insurer and/or governmental regulation, shall be randomly assigned a random unique identifier (also assigned at random), from a pool of available random unique identifiers and located in the extraction database. a.) This unique identifier, (to be referred to as the “UC” or “Unique Code” and it is a unique identifier that will never be reused), to then be recorded, as an individual file, which will also include these and other extracted fields regarding this transaction, and recorded in the extraction database(s). b.) This process is also simultaneously extracting data from other fields predetermined by insurer and/or governmental entity with regulatory authority, and shall extract at least two additional fields, one of which shall be a “suspension”, a “termination” or a “cancellation” status notification, (any and all of which are referred to as a “deactivations”), and one of which shall be either the policy number, the manufacturer's identification number or the UC. c.) Said files to be made available to be published/distributed immediately. D) The method of claim 3, wherein, the provision and transmission of a file containing all original data, all gleaned fields, all status updates and all assigned UCs, if any, directly to said insurer or governmental entity, which previously provided said original file, along with confirmation numbers of the transaction, then followed by an additional transmission to ensure full and proper receipt of same. This provision and transmission of data to use the same method of original transmission from insurer or government involved unless otherwise directed by same, but shall be at least a secure transmission in all cases, (for example, HTTPS, never HTTP). E) The method of claim 3, wherein, as with claims 1. J and 2. J, above, the methods of the above referenced claims, wherein any and all process sites for insurer or government data remains at the discretion of said insurer or government, provided any such site has the system software provided by the present invention. i.) Likewise, the insurer, except for specific government regulated requirements, and the automatic assignment of unique identifier, maintains total control over the software, and, ii.) insurer and/or government can activate or deactivate any automated element, and, iii.) insurer and/or government can operate any element in a manual mode at will, and, iv.) insurer and/or government can send files to a dedicated database referenced herein or to a government entity by choice or requirement. In all cases, the present invention will extract data fields, assign unique identifiers, record suspensions, terminations and cancellations, and provide both reporting and access for same in the manner herein described.

4. It is claimed that this present invention is a computer-implemented method for accurately determining the presence or absence of insurance on an object of value comprising the fourth step, which is the automatic forwarding of gleaned data and also the maintenance of gleaned data composed of the following elements: A) The method of claim 4, wherein, the present invention instantly forwards all extracted data fields required by both insurers and government entities with regulatory authority regarding same and which includes all information to be printed on insurance identification documents, including the unique identifier assigned, (also called the “UC”, or “Unique Code”), and all other fields required by insurers and government entities with regulatory authority, to the specific State government entities of the specific State government involved. B) The method of claim 4, wherein, the present invention instantly forwards all extracted data fields required by both insurers and government entities with regulatory authority regarding same and which includes all information to be printed on insurance identification documents, including the unique identifier, “UC”, (“Unique Code” assigned), to the specific personalization company, (if any), responsible for the production of said vehicle insurance identification cards and/or other, related documents, as directed by insurer and/or governmental entity. C) The method of claim 4, wherein, the present invention instantly forwards all extracted data fields required to be maintained in the aforementioned dedicated database(s) and/or aforementioned dedicated partitioned database node(s) for later access using the UC to gain status information. This data, which is a subset of other data already gleaned, is to contain no personal details of any kind. Specifically, no name, address, telephone number, or vehicle particulars can be parsed and then maintained, but instead, the manufacturer's identification number, policy number, NAIC code, (five digit code established by the National Association of Insurance Commissioners to identify insurers), the “UC”, source identifiers and status character are all that is normally maintained. All such requirements to be established by insurer(s) and government entities with regulatory authority and system is to be open to inspection by said insurers and said government entities at any time to confirm such compliance. D) The method of claim 4, wherein, a module consisting of the following elements maintains data: i.) a dedicated, centralized computer system for storing data, and comprised of: a.) relational database software b.) a computer server or partitioned node of a government computer server dedicated to the sole purpose of hosting the aforementioned database. c.) a system of redundant databases on redundant computer servers and/or computer server nodes to ensure service and continuity of aforementioned database. d.) a system of routers and other telephony and computer interface and communications devices to ensure proper communications at all times. e.) A copy of present invention elements as described previously in 3. A through I, above). f.) Protocol and telephony software so as to interface with any possible computer protocol and telephony standards utilized by an insurer. g.) High-level encryption software capable of protecting all data maintained. h.) Translator software so as to transform all data maintained into blind codes, and maintain as such except, when accessed, and translation from blind codes back into normal codes for use under the directions of insurers and government entities with regulatory authority. E) The method of claim 4, wherein, access to data is maintained on the previously referenced dedicated and secure server or partitioned government server node and supply of same in report format consisting of the following types: i.) Pre-established report formats and results of queries in said formats, accessible to insurers by use of access using various security measures and methods. ii.) “Wild Card” report formats and results of queries in said formats, accessible to insurers by use of access using various security measures and methods. iii.) Pre-established report formats and results of queries in said formats, accessible to government entities with appropriate authority by use of access using various security measures and methods. iv.) “Wild Card” reports formats and results of queries in said formats, accessible to government entities with appropriate authority by use of access using various security measures and methods. Except for use of the “UC”, these elements, (4. E. i. through iv.) above), are prior art, yet the use of the “UC”, (“unique code” the unique identifier), dramatically impacts access to and accuracy involving the above and the use of the “UC” in combination with this prior art is clearly part of the claims of the present invention.

5. It is claimed that this present invention is a computer implemented method for accurately determining the presence or absence of insurance on an insured object of value, comprising the fifth step, which offers therefore, the following elements as a consequence of the aforesaid, which further differentiate it from prior art in that its unique identifier, (also known as “unique code” or “UC”) enables: A) the method of claim 5, above, in which the present invention provides insurance verification via telephony or internet access at any time and to anyone without limitation because it is not limited in use to insurers or government agencies, but available to all, this access being safely enabled by its use of the aforementioned UC; B) the method of claim 5, above, in which the present invention is further distinguished by its ability to provide information on any policy without respect to insurer, location, jurisdiction, language, type of insured vehicle, time, and also the internal operations, software platform, and communications protocols used by insurers and/or governmental entities; C) the method of claim 5, above, in which the present invention is further differentiated in that it has no requirement to include names, addresses, or other personal data of any kind so that privacy issues are fully supported and no person or group can be identified and targeted in any manner; D) the method of claim 5, above, in which the present invention is further differentiated in that it extracts and maintains status data without the requirement to utilize internet or telephony connections to check an individual insurer regarding a specific policy or group of policies and with the attendant privacy, connectivity, and security issues involved in such prior art; E) the method of claim 5, above, in which the present invention is further distinguished from prior art in that, extracting data from data streams or data sources and having no need at any time to pass firewalls and/or interface with insurer main databases, (“stacks”), it is non-invasive to said insurer databases. F) the method of claim 5, above, in which the present invention is further distinguished by the supply of its issued unique identifiers for use by insurers as binder numbers, (or referenced by binder numbers) so that, in combination with its unique on-line/real time reporting, policyholders and/or owners can immediately affect registration(s), purchase(s), sale(s) or other transactions desired without delay; G) the method of claim 5, above, which further distinguishes the present invention by the supply of its issued unique identifiers for use by insurers as binder numbers, (or referenced by binder numbers), so that, in combination with its unique online/real time reporting, owners of the insured object of value can use same immediately in compliance with any regulations, legislation, contracts, or agreements that require such compliance; H) the method of claim 5, above, which further distinguishes the present invention by the supply of its issued unique identifiers for use by insurers as binder numbers, (or referenced by binder numbers), and also as the established means of access using same to insurance status information in future so that the failure to make a payment or other action that results in suspension, termination, or cancellation of a policy can be so reported and known the instant such action is determined and reported by insurer; I) the method of claim 5, above, which further distinguishes the present invention by the supply of its issued unique identifier, as the addition of only that number and a “toll free” number added to a printed document, thus allowing simple and accurate status verification, comprises a complete anti-fraud device; J) the method of claim 5, above, which further distinguishes the present invention in that, because of its use and more specifically the use of its issued unique identifier, the requirement to obtain and maintain large amounts of data does not exist, and, as a consequence file sizes are exceptionally small, so that response to the data maintained in the dedicated database is almost instantaneous; K) the method of claim 5, above, which further distinguishes the present invention by its ability to provide accurate information regarding multiple insurers, (an individual insurer may be able to provide current, accurate status regarding their own policies, but can supply no such information about the policies of other insurers). This is accomplished by the method of this claim 5 in that the use of same instead of prior art, (VIN—vehicle identification number, policy number, registration number, etc.) ensures that data will be recorded and then used correctly, as it cannot change. L) the method of claim 5, above, which further distinguishes the present invention in its ability to provide accurate information regarding multiple insurers' policies and as such, this system is able to report to insurers in the event that a single insured item of value has two or more policies associated with it, as that may be determined to be a possible case of fraud. M) the method of claim 5, above, which provides for access by Interactive Voice Response System, (“IVRS”), a commercially available computer and telephony equipment and software system which enables any user with a telephone to access the previously referenced database of the present invention by use of an “800” telephone number, and upon hearing audio prompts, enter the unique identifier, whereupon, a response regarding status is provided. Except for use of the UC, this element is prior art, but the UC enables all users for the first time to accomplish this task in a safe, non-invasive manner. This, in turn means that anyone can use the present invention, not just law enforcement and insurers. N) the method of claim 5, above, which provides for access by Touch-Tone Response System, a commercially available equipment and software system; this enables any user with a touch-tone telephone to, upon hearing audio prompts, to first choose his or her preferred language, then prompts the user in chosen language if available, (or reverts to the use of English as default), to enter the unique identifier, (the “UC”), whereupon a response regarding status is provided in said language. Except for use of the UC, this element is prior art but the UC enables all users for the first time to accomplish this task in a safe, non-invasive manner. This, in turn means that anyone can use the present invention, not just law enforcement and insurers. O) the method of claim 5, above, which provides for access by internet, client-server and/or intranet using a computer. Web page access is fully enabled for infrequent users, APIs are provided for frequent users, while T1, SDSL and similar may be provided to and used by government entities and large insurers. Except for the use of the UC, this element is prior art but the UC enables all users for the first time to accomplish this task in a safe, non-invasive manner. This in turn, means that anyone can use the present invention, not just law enforcement and insurers. P) the method of claim 5, above which provides for access via Java, XML, .NET, or other such portals for use by GPRS, CDPD, CDMA telephony, Cellemetry, Mobitext, GSM telephony, paging frequencies, or any other wireless protocols or technologies. Except for the use of the UC, this element is prior art but the UC enables all users for the first time to accomplish this task in a safe, non-invasive manner. This, in turn means that anyone can use the present invention, not just law enforcement and insurers.
